(19) United States
(12) Patent Application Publication
(10) Pub. No.: US 2024/0316768 A1
(43) Pub. Date: Sep. 26, 2024

(54) SYSTEMS AND METHODS FOR PROCESSING A WORKSURFACE

(71) Applicant: 3M INNOVATIVE PROPERTIES COMPANY, St. Paul, MN (US)

(72) Inventors: Daniel M. Bodily, Woodbury, MN (US); Brett R. Hemes, Woodbury, MN (US); Xin Dong, Woodbury, MN (US)

(21) Appl. No.: 18/579,421

(22) PCT Filed: Jul. 20, 2022
(86) PCT No.: PCT/IB2022/056718

§ 371 Date: Jan. 15, 2024

Related U.S. Application Data
(60) Provisional application No. 63/203,410, filed on Jul. 21, 2021.

(51) Int. Cl. B25J 9/16; B25J 11/00; B25J 19/02; G05B 19/42

(52) U.S. Cl. CPC B25J 9/1664; B25J 9/1684; B25J 11/0065; B25J 19/023; G05B 19/4207; G05B 2219/35132

(57) ABSTRACT

A robotic system is presented that includes a surface inspection system that receives sampling information for a number of areas within a region of a worksurface. The system also includes a robotic arm, coupled to a surface engaging tool, the robotic repair arm being configured to cause the surface processing tool to engage the region of the worksurface. The system also includes a process mapping system configured to, based on the sampling information: approximate a surface topography in the region of the worksurface, generate a surface processing plan for the region based on the approximated surface topography that includes a trajectory. The surface processing plan includes one of: a force profile along the trajectory, a velocity profile for the surface engaging tool along the trajectory, a rotational speed profile, for the surface engaging tool, along the trajectory, or a trajectory modification that accounts for the presence of a surface feature identified in the approximated surface topography. The process mapping system is also configured to generate a control signal for the robotic arm that includes the surface processing plan.

### BACKGROUND

Clear coat repair is one of the last operations to be automated in the automotive original equipment manufacturing (OEM) sector. Techniques are desired for automating this process as well as other surface processing applications, including paint applications (e.g., primer sanding, clear coat defect removal, clear coat polishing, etc.), adhesive dispensing, film wrapping applications, or material removal systems are amenable to the use of abrasives and/or robotic inspection and repair. Defect repair presents many challenges for automation.

### SUMMARY

A robotic system is presented that includes a surface inspection system that receives sampling information for a number of areas within a region of a worksurface. The system also includes a robotic arm, coupled to a surface engaging tool, the robotic repair arm being configured to cause the surface processing tool to engage the region of the worksurface. The system also includes a process mapping system configured to, based on the sampling information: approximate a surface topography in the region of the worksurface, generate a surface processing plan for the region based on the approximated surface topography that includes a trajectory. The surface processing plan includes one of: a force profile along the trajectory, a velocity profile for the surface engaging tool along the trajectory, a rotational speed profile, for the surface engaging tool, along the trajectory, or a trajectory modification that accounts for the presence of a surface feature identified in the approximated surface topography. The process mapping system is also configured to generate a control signal for the robotic arm that includes the surface processing plan.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a schematic of a robotic surface processing system in which embodiments of the present invention are useful.

FIG. 2 illustrates a method of robotic defect repair in which embodiments of the present invention may be useful

FIG. 3 illustrates a worksurface with multiple surface features in which embodiments herein may be useful.

FIG. 4 illustrates a method of processing a worksurface in accordance with embodiments herein.

FIG. 5 illustrates a method of identifying surface features on a worksurface in accordance with embodiments herein.

FIGS. 6A-6B illustrates feature detection on a surface in accordance with embodiments herein.

FIGS. 7A-C illustrate modified trajectories in accordance with embodiments herein.

FIGS. 8A-8D illustrate a method of modifying a trajectory in accordance with embodiments herein.

FIGS. 9A-9E illustrate modified trajectories in accordance with embodiments herein.

FIG. 10 illustrates a method of generating a modified surface processing strategy in accordance with embodiments herein.

FIG. 11 illustrates a process mapping system in accordance with embodiments herein.

FIG. 12 is a surface processing strategy generation system architecture.

FIGS. 13-15 show examples of computing devices that can be used in embodiments shown in previous Figures.

FIG. 16 illustrates an example parameter adjustment for a modified trajectory.

### DETAILED DESCRIPTION

Recent advancements in imaging technology and computational systems has made feasible the process of clear coat inspection at production speeds. In particular, stereo deflectometry has recently been shown to be capable of providing images and locations of paint and clear coat defects at appropriate resolution with spatial information (providing coordinate location information and defect classification) to allow subsequent automated spot repair. As automated imaging of worksurfaces improves, it is equally desired to improve the ability to automatically process worksurfaces. For example, in the case of clear coat repair, it is desired to repair detected defects, using a robotic repair system, with as little manual intervention as possible. However, as discussed herein, a worksurface exhibiting a high degree of curvature (one that deviates significantly from being a flat surface) is particularly challenging to process with a robotic system. Additionally, the presence of sharp surface features (tight bends, grooves, etc.) near the desired repair region can further complicate efforts to perform an automated repair. While humans intuitively know how to change their approach to deal with a convex or concave surface feature, robotic systems have to both be informed about surface features and trained how to adjust preprogrammed trajectories to accommodate the surface feature, when detected. The systems and methods herein may be useful in any surface processing application in which a surface processing task must be mapped to a surface that exhibits significant curvature and/or surface features.

As used herein, the term “vehicle” is intended to cover a broad range of mobile structures that receive at least one coat of paint or clear coat during manufacturing. While many examples herein concern automobiles, it is expressly contemplated that methods and systems described herein are also applicable to trucks, trains, boats (with or without motors), airplanes, helicopters, etc. Additionally, while vehicles are described as examples where embodiments herein are particularly useful, it is expressly contemplated that some systems and methods herein may apply to surface processing in other industries, such as painting, adhesive processing, or material removal, such as sanding or polishing wood, plastic, paint, etc.

The term “paint” is used herein to refer broadly to any of the various layers of e-coat, filler, primer, paint, clear coat, etc. of the vehicle that have been applied in the finishing process. Additionally, the term “paint repair” involves locating and repairing any visual artifacts (defects) on or within any of the paint layers. In some embodiments, systems and methods described herein use clear coat as the target paint repair layer. However, the systems and methods presented apply to any particular paint layer (e-coat, filler, primer, paint, clear coat, etc.) with little to no modification

As used herein, the term “defect” refers to an area on a worksurface that interrupts the visual aesthetic. For example, many vehicles appear shiny or metallic after painting is completed. A “defect” can include debris trapped within one or more of the various paint layers on the work surface. Defects can also include smudges in the paint, excess paint including smears or dripping, as well as dents.

Paint repair is one of the last remaining steps in the vehicle manufacturing process that is still predominantly manual. Historically this is due to two main factors, lack of sufficient automated inspection and the difficulty of automating the repair process itself. Humans interacting with a surface have an instinctive understanding of how to accommodate surface curvature, edges or other features. Robotic surface processing systems require training.

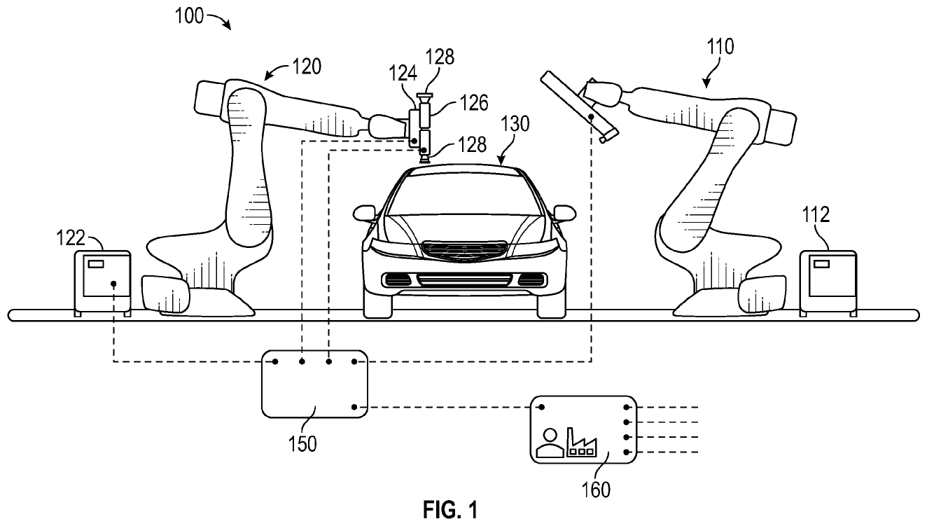

FIG. 1 is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, end effector 126 includes two processing tools 128. However, other arrangements are also expressly contemplated.

The current state of the art in vehicle paint repair is to use fine abrasive and/or polish systems to manually sand/polish out the defects, with or without the aid of a power tool, while maintaining the desirable finish (e.g., matching specularity in the clear coat). An expert human executing such a repair leverages many hours of training while simultaneously utilizing their senses to monitor the progress of the repair and make changes accordingly. Such sophisticated behavior is hard to capture in a robotic solution with limited sensing.

Additionally, abrasive material removal is a pressure driven process while many industrial manipulators, in general, operate natively in the position tracking/control regime and are optimized with positional precision in mind. The result is extremely precise systems with extremely stiff error response curves (i.e., small positional displacements result in very large corrective forces) that are inherently bad at effort control (i.e., joint torque and/or Cartesian force)). Closed-loop force control approaches have been used (with limited utility) to address the latter along with more recent (and more successful) force controlled flanges that provide a soft (i.e., not stiff) displacement curve much more amenable to sensitive force/pressure-driven processing. The problem of robust process strategy/control, however, remains and is the focus of this work.

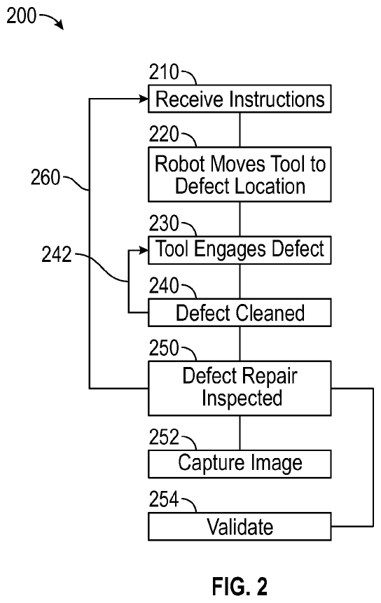

FIG. 2 illustrates a method of robotic defect repair in which embodiments of the present invention may be useful. Method 200 is an overview of how a robotic repair system repairs a defect in accordance with at least some embodiments described herein.

In block 210, instructions are received from a robot controller, such as application controller 150 in FIG. 1, for example. The instructions include movement instructions for different components of a robotic repair unit, such as a force control unit, end effector motor or tool movement patterns, etc.

In block 220, a robotic motion controller moves an abrasive article, mounted to a tool, in place to prepare to engage a defect. Defect locations may be known from an inspection system or otherwise identified, for example based on a CAD file of the worksurface.

In block 230, the abrasive article engages the defect. Engaging the defect may include sanding the defect area or polishing the defect area.

In block 240, the defect area is cleaned. Cleaning may include wiping away any fluids used in sanding or polishing, as well as wiping away debris. As indicated in block 342, after a cleaning step, the tool may re-engage the defect.

In block 250, the defect area is inspected, to determine whether the repair is sufficient. If additional repair is needed, method 200 may include the robotic repair unit receiving new instructions, as indicated by arrow 260, and the method may repeat. Inspecting a defect repair may include capturing post-repair images 252, which may be presented to a repair operator or saved as needed. Inspecting may also include validating the repair, as indicated in block 254, which may include comparing pre- and post-repair images, detecting whether a defect will be visible/noticeable to the human eye, or another suitable validation technique.

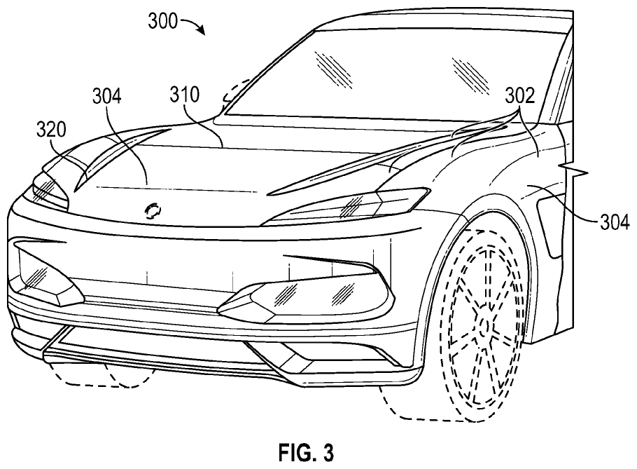

FIG. 3 illustrates a worksurface with multiple surface features in which embodiments herein may be useful. A worksurface 300, illustrated as an automobile hood in FIG. 3, includes a surface with a number of surface features 302, and some flat areas 304. Currently, defects are detected by an inspection system and provided to a human reviewer who indicates whether defects are in a repairable area or a non-repairable area. A repairable defect 310, is a defect that is in an area on worksurface 300 that a robotic repair unit can repair using repair trajectories based on a flat repair surface. In contrast, a defect too close to a surface feature 302 is deemed a manual repair defect 320, or a defect that must be repaired by hand because it cannot be done by a robotic surface processing system. Currently, in many applications, imaged defects are mapped to regions of a vehicle with a pre-proscribed routine and “repair/do not repair” criteria. For example, areas that are “tight” or on a curved (concave or convex) surface are “do not repair” areas.

It is desired to have a system or method that allows for a robotic surface processing system, such as system 100, be able to process surfaces close to, or on areas including, surface features. Additionally, it is also desired to have a system that can determine surface topography near a defect location without access to a CAD (computer-aided design) model of a vehicle, or other worksurface, as it may not always be possible to obtain such models from vehicle manufacturers. For example, when conducting a repair in an after-market context, such as a body shop, the only way to gather surface data may be by using direct measurement.

As described herein, in some embodiments, a defect is identified and a number of points on a surface around the defect are measured. A point cloud is therefore obtained and, based on the point cloud, topography of a surface is determined. In some embodiments, based on the surface topography, a surface feature is identified. In some embodiments, a series of curvature metrics are computed at many sampled points taken from the model that has been fit from measurements. At each sampled point, these metrics are computed with respect to two orthogonal vectors (these vectors coinciding with the principle axes of curvature around which the surface is bending the most at that point). Explicitly, at each sampled point two vectors aligning with the principal axes of curvature are computed along with the associated curvature magnitudes and curvature derivatives along those axes. Because the CAD model of a surface may not be available, as described herein, mathematical modeling is needed to approximate curvature near the defect in order to identify surface features.

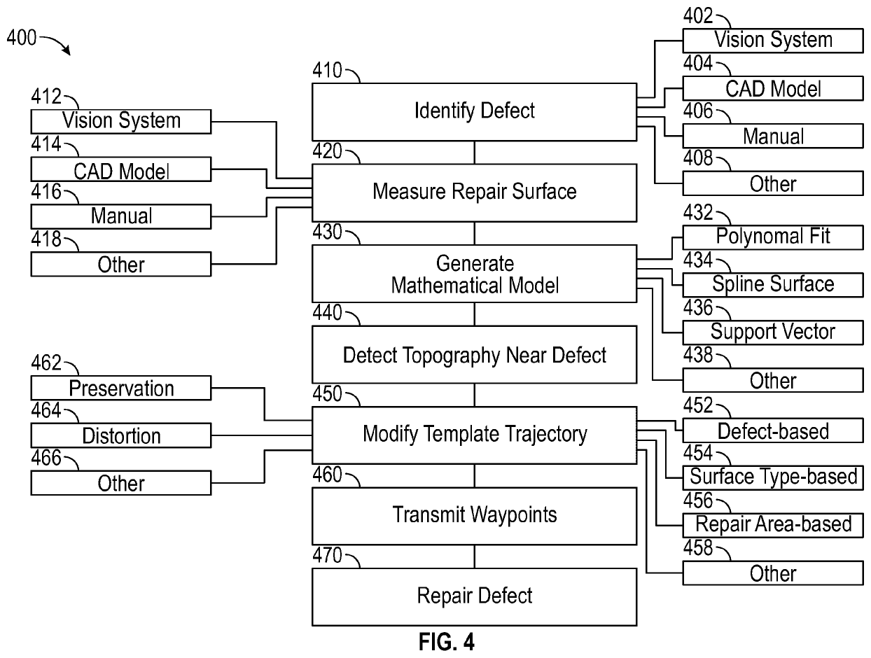

FIG. 4 illustrates a method of processing a worksurface in accordance with embodiments herein. Method 400 may be implemented into a system such as system 100. However, some steps of method 400 may be performed at different locations, for example a defect may be identified, as indicated in block 410, by an inspection system that is in a different location than a repair robot that repairs the defect in block 470. Further, a mathematical model estimating curvature may be generated locally at either the inspection system, the robotic repair location, by a local robot controller, or at a third location, such as by a cloud-based server or remote robot controller. Method 400 is discussed in the context of robotic repair of paint or clear coat defects on vehicles. However, a similar method may be useful in other industries.

In block 410, a defect is detected in a surface of a vehicle. The defect may be a dent, scratch, embedded particle in a layer of clear coat or paint, an air bubble or a smudge. The defect may be identified using a vision system, as indicated in block 402, that images the worksurface and, based on the images, identifies a defect. The defect may also be identified based on a CAD model, as indicated in block 404, for example by feeding information to a CAD model so that the defect location can be defined with regard to known surface features. In block 406, the defect may be identified, at least partially, by a manual process, such as an individual identifying a defect as a scratch, and marking it for repair such that a vision system can identify the location, or by feeding a measured location to a CAD system. Other options for identifying a defect type or location on a vehicle surface are also envisioned.

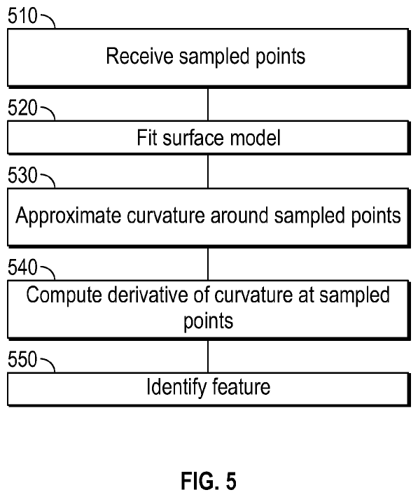

In block 420, the repair surface is measured. In some embodiments, as indicated in block 414, a CAD model provides precise measurements of surface topography at the defect location and surrounding the defect location. However, it may not always be possible to get CAD models for every worksurface. Therefore, as discussed in greater detail with respect to FIG. 5 and method 500, it may be possible to use a vision system, as indicated in block 412. It may also be possible to obtain some surface measurements manually 416, or using another method, as indicated in block 418.

In block 430, a mathematical model is generated and used to approximate surface topography at a number of points on the worksurface, for example the points measured in block 420. Model 400 may be useful for high resolution surface topography modeling as well as low resolution surface topography modeling, in different embodiments. In some embodiments, low resolution surface topography relies on a small number of surface sampling measurements, for example 25 or fewer points, 20 or fewer points, 15 or fewer points, 10 or fewer points. In an embodiment where a bivariate quadratic model is used (such as F(x,y)=ax²+by²+cxy+dx+ey), a minimum of five points is required in order to solve for the five constant values (e.g. a, b, c, d, and e). As described herein, in a low resolution scenario, a surface topography model can befit, which can then serve as the basis onto which a surface processing operation may be mapped. In this embodiment, surface measurements used to fit the model are assumed to have been provided in a frame centered over the defect (thus no translational constant is needed in the fit model). However, it is expressly contemplated that, in some embodiments, a translational constant may be needed, if surface measurements are provided in a frame not centered over the defect. Other models may also be used, which may require more, or fewer, points to solve for each constant.

In high resolution scenarios, a greater number of surface samples are obtained, for example at least 50 points are sampled, or at least 100 points, or at least 200 points, or at least 300 points, or more. The greater number of points sampled, the more accurately the surface topography model will be in approximating the underlying surface. For example, a 6 cm diameter region may use 300 sampled points to approximate the surface topography and detect surface curvature. In high-resolution sampling scenarios, it is possible to fit a higher-order mathematical model that more accurately captures the topographical features that characterize the underlying surface (grooves, sharp bends etc.). It is then possible to use this higher order model to detect these features by identifying regions where the derivative of curvature “crosses zero” along a principal axis of curvature. It may then be possible to adapt a robot trajectory based on the detected surface feature and/or surface topography.

Using a model to approximate the surface may allow a robot controller to take a very minimal set of data describing the surface. The mathematical model generated in block 430 may be sufficient to approximate the surface around the defect to allow for a custom repair operation to be tailored to that area of the worksurface. The mathematical model generated in block 430 enables a robotic controller to execute a quality repair without being fully aware of the underlying surface data. Instead, a surface processing system can receive surface measurements and use these measurements to plan and map repairs onto the target surface. The method may include any polynomial surface approximation method, as indicated in block 434, such as a quadratic fit, a cubic fit, a quartic fit, etc. Such a model allows for approximating surface properties directly from equations without needing to keep sampling. The mathematical model may, in some embodiments, be fit using least squares linear regression, as indicated in block 434. Other models may be used, as indicated in block 438. For example, when more data is available, the mathematical model may be composed of a higher dimensional representation of the surface including a surface fit using splines (B-Splines, NURBS, etc.), in one embodiment, or a support vector machine, in another embodiment.

In block 440, a feature is detected near a surface defect. The feature may be a concave surface, a convex surface, an edge, a protrusion or another surface feature that may inhibit a normal repair trajectory.

In block 450, based on a detected feature, or based on known or approximated surface curvature, or based on surface topography, a surface processing template is retrieved and modified. A repair template is a set of waypoints in a 2D plane with associated process parameters assigned at or between each point (e.g. applied force, disk speed, robot dynamics etc.). It defines a generic set of instructions for a robot to perform a surface processing operation.

The template may be modified depending on the computed curvature metrics. For example, it may be desirable that a process parameter assigned at or between two waypoints (applied force e.g.) be modified as to be proportional to the magnitude of maximum surface curvature present between these two points. Another example might be modifying (for example, by scaling up or down) the force profile applied across a set of waypoints in a repair template depending on if the surface is detected to be concave or convex at those points.

The shape of the template may also be modified depending on the approximated curvature metrics. For example, a repair template may be distorted as to warp it around a detected surface feature. This enables a robot to process defects near surface features without having to perform highly dynamic maneuvers that may cause scuffing or other undesirable effects.

Once the template is appropriately modified (both its process parameters and shape), it is then mapped from a 2D reference plane above the defect, onto the surface using the fit surface model.

The template may be retrieved based on a detected defect type or size, as indicated in block 452. The template may be retrieved based on a type of surface, for example type or color of paint, type of clearcoat, or other surface conditioning, as indicated in block 454. The template may also be retrieved based on an area of worksurface under repair, as indicated in block 456. In the example of a defect in a repair area on a hood of a car, a repair template with increased feathering at the edges may be retrieved, as opposed to if the repair area is on a lower edge of a door, where increased feathering may not be needed. The modification may preserve the repair trajectory in some capacity, as indicated in block 462, for example waypoints may undergo a transformation in which their positions are shifted only in a radial direction with respect to a central point defined in the repair template. The modification may also include a distortion metric, as indicated in block 464 to allow the defect to be addressed without interfering with the surface feature. Other modification methods may be used, as indicated in block 466, to allow a robotic repair tool to sufficiently address the defect while avoiding the surface feature.

In block 460, waypoints associated with the repair are generated and sent to a robotic repair system, such as system 100. The waypoints may be generated based on the known defect location. The waypoints may cause a robotic repair unit to move a repair tool to the defect location and follow the modified trajectory. The waypoints may be based on the approximated surface around the defect to sufficiently process, or repair, the work surface. The waypoints may be generated by mapping the modified trajectory to the surface. The mapping may include orthogonal mapping or another suitable technique.

In block 470, the robotic repair unit follows the modified trajectory to conduct a successful repair of the defect. Using method 400, a robotic repair unit can repair surfaces with no known geometry model available.

Currently, many areas on a vehicle surface are classified as “no go” zones for a robotic repair unit. Defects in areas with curved surfaces or edges require modification to repair trajectories. Humans conducting repairs can intuitively adjust how to repair a curved surface, adjusting movements, force and velocity. Systems and methods described herein may assist in modifying repair trajectories to reduce the number of “no go” zones on a vehicle. However, it is expressly contemplated that systems and methods herein may still classify some areas as unrepairable based on detected topography. Detecting an area as too difficult to repair based on detected topography obviates the need for “no-go zones” to be hand labeled and continually managed as a part may undergo design changes.

FIG. 5 illustrates a method of identifying surface topography of a worksurface in accordance with embodiments herein. The use of point-cloud methods for feature detection is not unknown. For example, Kim et. al, “Extraction of Ridge and Valley Lines from Unorganized Points.” Multimedia tools and applications 63.1 (2013), pp 265-279 describes such a method. As described herein, the mathematical model of method 500 differs in how polynomial surfaces are fit to a work surface and in how extremal crossings are detected. Additionally, in some embodiments method 500 relies on a sampling of patches around a defect position of interest, stitching the corresponding polynomial fits together to provide a near continuous representation of the surface for efficient interpolation. However, other methods of fitting may be suitable, such as fitting a NURBS surface, then using the equations from that model to compute derivatives, curvature, and then derivatives of curvature. Other methods may also be suitable.

In block 510, a number of points on a surface are obtained. Samples points are obtained from a separate system, such as a vision system, for example, that samples the area around a detected defect. The points are, in one embodiment, sampled systematically based on a grid measurement as described in U.S. Provisional Application No. 63/203,407. A plane is defined at a defect location and aligned with respect to the surface normal at that location. A grid of points lying within a radius Rm of the central defect location (as measured in this plane) are then projected to the surface, providing a sampling of depth measurements with respect to this plane. These projected points are used to fit a surface approximation model. Points in a planar grid are projected onto a worksurface of interest used to measure the local surface topography. The Z-axis (out of the page) at the center point of sampling is aligned with the surface normal of the point of interest (e.g. the defect). Depth values are then measured from points lying within a radius of R_{M} from the center of the grid. These points are used to fit a surface approximation model.

In block 520, an approximation model is constructed. In one embodiment this is done by fitting a series of local approximation models, one at each sample point lying within a radius R_{f} of the defect point, as measured in the sampling plane described above. Each local surface model is fit using a ‘patch’ of nearby points lying within radius Rₚ of the sample point over which the patch is centered, as measured in the sampling plane. This local model is an analytical approximation of a subregion of the repair area on the underlying surface and can be used to compute curvature metrics in that subregion. In one embodiment, a local model may be composed of a bivariate polynomial function fit to a subregion using least squares regression.

Other methods may be used to fit a global approximation model directly from the entire set of measurement points taken from the surface. Such methods may employ surface approximations that are composed of splines. For example, one such approach is presented in Simple Method for Constructing NURBS Surfaces from Unorganized Points, Leal et al., Proceedings of the 19th International Meshing Roundtable pp 161-175.

In some embodiments, only local fit functions are used for each sampled point, such that no global fit is required, and surface quantities can be compared across local approximations of the surface.

In block 530, curvature metrics are approximated at a set of sample points generated from the mathematical model. These points may be sampled from the analytical surface model at a finer resolution than that of the original surface measurements. A set of metrics describing surface topography is computed at each sample point using the approximation model fit in 38. These metrics include the magnitudes (k₁, k₂) of surface curvature along the principle axes of curvature (v₁, v₂), as well as the associated derivative of curvature along each axis (e₁, e₂).

The analytical model used for this discussion is presented as Equation 1 below. However, it is expressly contemplated that other models are possible. Letting the surface be modeled by a series of bivariate, quadratic approximation functions, we obtain an implicit form each approximating function as,

$$F ( x , y ) = z ( x , y ) - ( a {x}^{2} + b {y}^{2} + c x y + d x + e y + d ) \qquad Equation 1$$

The gradient of F is taken and normalized to find a vector N that is normal to the surface, as illustrated in Equation 2, below:

$$N ( X , Y ) = \frac{( ∇ F ( x , y ) )}{\vert ∇ F ( x , y ) \vert} \qquad Equation 2$$

An Eigen Decomposition of the gradient of the normal vector (∇N) is then taken. The two eigenvectors associated with the two largest (based on absolute value) eigenvalues are vectors that lie along the principal axes of curvature. Letting H be the Hessian (matrix of second partial derivatives) of F, the associated curvature along a vector v can be computed using Equation 3 (as shown in Kim et al.).

$$k = \frac{{v}^{T} H v}{\vert ∇ F \vert} \qquad Equation 3$$

At each sampled point, there are two principle axes of curvature, a minimum and a maximum, each with an associated value of curvature. Each curvature value represents the inverse of the radius of a circle that osculates the surface along the associated axis. The principle axes of curvature (v₁, v₂) at each point may be found by taking an eigen decomposition of the gradient of the normal vector at that same point as discussed above. The metrics of k and v provide a method for analytically determining how much, and in which direction, a surface is “folding” at any given sample point.

The derivative of curvature along vector v can be computed using Equation 4 (also shown in Kim et al.).

$$e ( k , v ) = ∇ k v = \frac{{T}_{ijk} {v}^{i} {v}^{j} {v}^{k} + 3 k {H}_{ij} {v}^{i} {n}^{j}}{\vert ∇ F \vert} \qquad Equation 4$$

where T is a 3×3×3 tensor of the third partial derivatives off. We compute these in both principle axes to obtain the derivatives of curvature (e₁, e₂). Equations 3 and 4 come from Kim et al. However, while the use of these equations are discussed in the context of a bivariate cubic polynomial approximation, it is expressly contemplated that these equations can be used on any analytical model by following the same steps as outlined. In doing so the polynomial, in Equation 1 would be replaced by the analytical model of choice. For example, if a NURBS surface S(x,y) has been fit from a set of measurements, then Equation 1 would be adapted to become, F(x,y)=z(x,y)−(S(x,y)), and the method would proceed as outlined.

In block 540, the derivative of curvature along each principle axis of curvature is computed at each point sampled from the analytical model.

In block 550, points where the derivative of curvature along a principle axis of curvature crosses zero are approximated. Zero crossings in the derivatives of curvature (e.g. where e₁, e₂ change signs across neighboring points) correlate with valleys and ridges, e.g. surface features, on a surface. Surface features can, therefore, be detected by comparing the local approximations of the curvature of derivatives (e₁, e₂) across sample points.

It is duly noted in the literature that the principle axes of curvature are directionally ambiguous. This can lead to random flipping of the computed eigenvectors (v₁, v₂) which in turn can lead to false feature point detections (the signs of e₁ and e₂ also flip).

To account for this, when checking if a zero crossing of the derivative of curvature (e) exists between two sample points, the associated principle directions are aligned locally. For example, if eigenvector v₁ at pt1 is not found to be within 90 degrees of eigenvector v₁ computed at a neighboring point, the representation at pt1 is flipped (v₁ and e₁ are both negated). Once they align, a change in sign of e1 compared across these neighboring points reveal an associated feature point.

After aligning axes of curvature between neighboring points, a feature point is detected if the sign of the derivative of curvature changes. The sign of the value of curvature (k) at the e-crossing indicates whether the surface feature is a ridge or a valley, and the magnitude of the value of curvature provides a metric for how sharp the ridge or valley is. For example, a feature point may be ignored if the magnitude of curvature (|k|) computed at that feature point is found to be less than a user-defined tolerance, as this point may not be significant enough to warrant special consideration when performing a repair.

When a feature point is detected to lie between two sampled points, the values of the derivate of curvature at those points are used to determine a more accurate estimate of the point of crossing, using Equation 5, below.

$${p}_{e} = \frac{\vert {e}_{2} \vert}{\vert {e}_{1} \vert + \vert {e}_{2} \vert} {p}_{1} + \frac{\vert {e}_{1} \vert}{\vert {e}_{1} \vert + \vert {e}_{2} \vert} {p}_{2} \qquad Equation 5$$

This is in contrast to Kim et. al.'s method which assigns the smallest value of the derivative of curvature to be the “detected ridge point”. With a global approximation model, it is contemplated that even more accurate methods of detecting exact crossings are conceivable. These could be done using root-solving techniques such as Newton Raphson.

For a robotic repair unit to be able to repair a curved surface, a path may be projected directly onto a CAD model that represents that surface. This assumes that the trajectory planner has full access to the CAD data and can thereby perform such path projection. In practice, these CAD files can be hard to manage due to their complexity, dynamic nature (a part might go through several redesigns for example), and the underlying intellectual property agreements that must be established before such data can be shared. Using method 500, a robotic repair unit can complete method 400 without needing the robot controller to be aware of and manage these CAD files, instead allowing sensors or an auxiliary system to provide it with sample points from which the surface is approximated locally.

Once a model approximating the surface has been fit, using method 500 for example, waypoints defining a templated robot repair trajectory can be mapped from a 2D plane onto the 3D approximation. One realization of this mapping is via orthogonal projection. Other more advanced means of mapping these path points are also conceivable including those that seek to limit radial distortion introduced by the 2D to 3D projection of the repair path.

Once curvature information is modeled for a surface, a continuous feed of data is available for adjusting process parameters at points along the repair trajectory, for example applied force, tool approach angle, movement speed, rotational speed (for a spinning tool) or dispensing speed (for a dispenser). Each of these parameters can be adjusted at each point along the trajectory, within process constraints, to address surface features. The analytical models described herein provide a smooth surface topography onto which discrete repair points can be mapped. The surface topography can be sampled as finely or coarsely as desired. The discrete samplings can be used to fit a spline curve, which can then be used as the basis for modification of applied force at each point on the path.

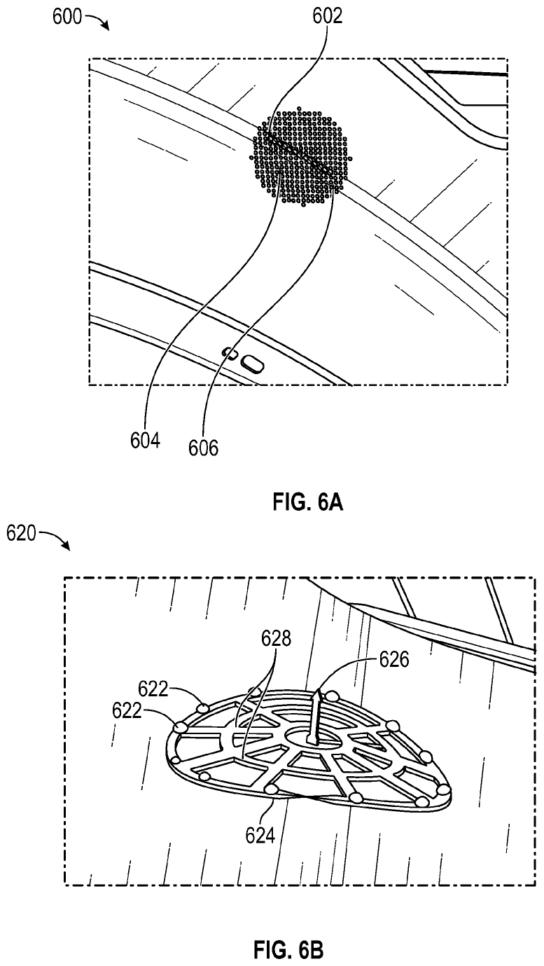

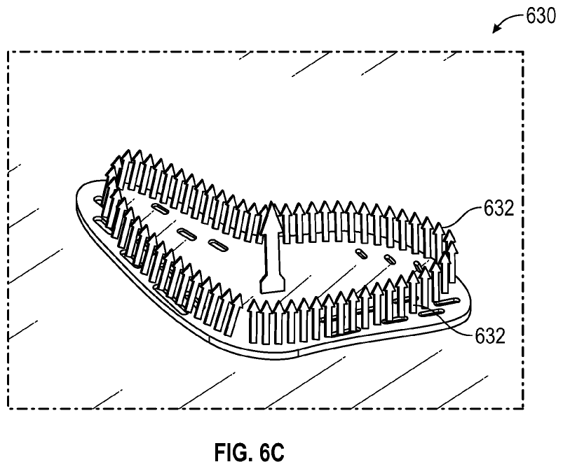

FIGS. 6A-6B illustrates a mapped trajectory on a surface in accordance with embodiments herein. FIG. 6A illustrates the results of mathematically modeling a worksurface with a surface feature, the process of which is shown in the Examples described in U.S. Provisional Application No. 63/203,407, filed Jul. 21, 2021. A set of measurements 602, 604 is sampled on a CAD surface 600 representing a vehicle. An analytical model is fit to these points and the derivative of curvature is measured at each sample point. Where the derivative of curvature flips signs a feature line 602 is detected. Repairs near this region may then be transformed either to avoid this feature line, or to run parallel and/or perpendicular to it. Path speed, tool force and tool velocity may also be adjusted.

FIG. 6B illustrates one example trajectory applied to the modeled surface 630. Normals 632 to a contact surface are illustrated, showing how an attack angle might change to accommodate the surface topography.

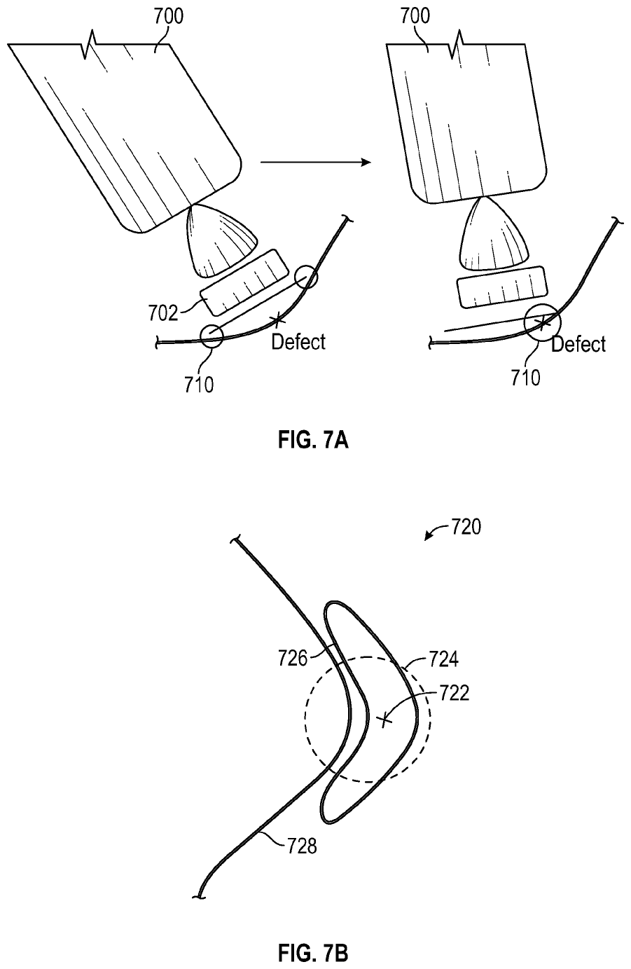

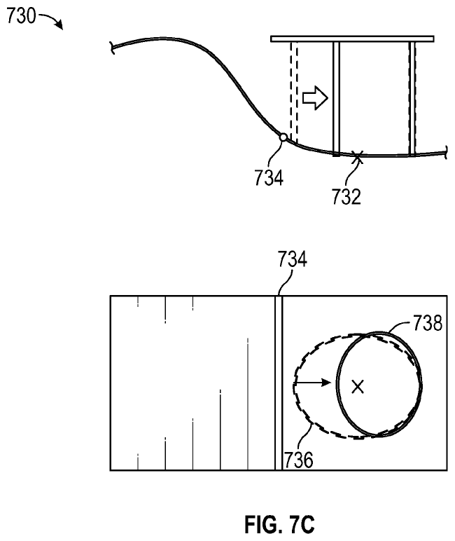

FIGS. 7A-7C illustrate different ways that a trajectory may be changed. FIG. 7A illustrates how an attack angle of a surface processing unit 700 might change in order to address a defect in a concave area. A surface processing unit 700 needs to contact a defect with a tool 702 in the embodiments shown. On the left, tool 702 will collide with surface portions 710 and not interact with the defect until significant damage is caused by gouging into surfaces 710, leaving a highly visible surface processing operation, which is not desired in material removal applications. Instead, when the surface topography is provided to a robot controller, the attack angle can be adjusted, as seen on the right, so that tool 702 interacts with area 710 containing the defect, which will result in a much less noticeable surface processing mark.

In the context of a broader repair strategy generation process by a robot controller, knowing the surface topography may change an order of defect repair, for example repairing this defect while a tool 702 with a smaller surface area is attached to unit 700. Or, in a system with two units 700, assigning a unit 700 with a smaller tool 702 to address the illustrated defect.

FIG. 7B illustrates a nonlinear transformation 720 of a trajectory around a curved surface. Surface processing near a surface feature can be done, generally, in two ways—either by incorporating the surface feature into the repair strategy, as illustrated in FIG. 7B, or by avoiding the surface feature, as illustrated in FIG. 7C. In FIG. 7B, a defect 722 is located on a curved surface 728. An initial defect strategy might be, for example, a circular repair 724 about defect 722. However, a circular repair mapped onto the surface containing defect 722 would potentially leave undesired markings on the surface as the robot would have to perform highly dynamic maneuvers in order to follow the contoured surface. This is not preferred. Instead, it is desired to deform, and wrap the repair trajectory around, and incorporating, the curvature of surface 728, resulting in trajectory 726. In some embodiments, the transformation of trajectory 724 to trajectory 726 is a homeomorphic transformation, such that every point on trajectory 724 maps to a point on trajectory 726. While FIG. 7B illustrates a transformation that extends trajectory 726 beyond the radius of trajectory 724, at least in some directions, it is also expressly contemplated that a homeomorphic transformation may occur that keeps trajectory 726 within the bounds of trajectory 724. Additionally, while FIG. 7B illustrates a circular trajectory 724 that transforms to a boomerang-like shape 726, it is expressly contemplated that other shapes may be suitable or appropriate, such as a bean-shape, an oval, or another suitable shape, for example including a scalar increase or decrease in a trajectory diameter. The shape of a trajectory 724 may be dictated based on the shape or size of the defect to be repaired, and the resulting shape and size of trajectory 726 may be dictated based on the shape, size or magnitude of curvature of a surface feature. While homeomorphic transformations have been discussed that generally maintain a trajectory shape, it is possible that other transformations may be appropriate based on surface topography and defect specifications. For example, a spiral may be preferred around a groove, with a zig-zag pattern used within the groove. The transformation from a spiral to a line is an example of a non-homeomorphic transformation. Similarly, all points in an area beyond a feature line may be mapped to a line bordering the feature line, in a non-homeomorphic transformation.

FIG. 7C illustrates a transformation 730 that modifies the geometry of a trajectory. An initial trajectory 736 is selected for a defect 732. However, trajectory 736 would bring a surface processing tool too close to a surface feature 734, likely causing damage outside of the desired defect repair zone. Therefore, a modified trajectory 738 is generated. As illustrated in FIG. 7C, modified trajectory 738 is off-center from defect 732, however it might be centered over defect 732, in other embodiments. A linear transformation may stretch, rotate or translate a defect, as illustrated in FIG. 7C.

However, it may not be possible to achieve a defect repair by simply stretching, compressing or translating a trajectory.

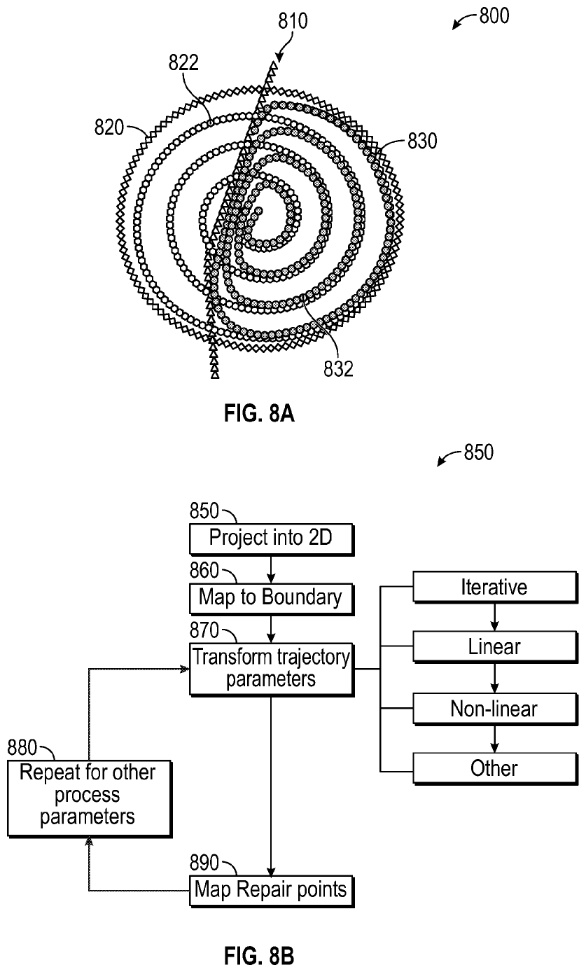

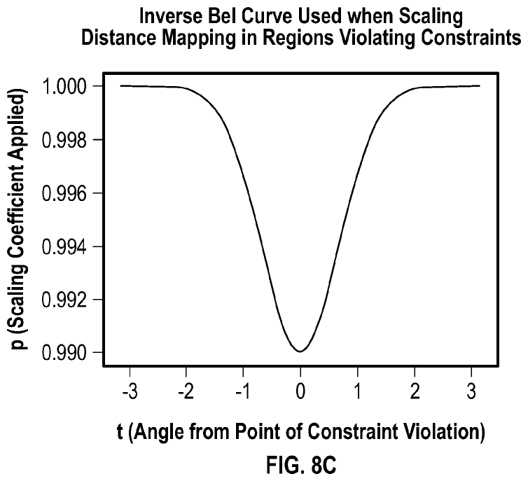

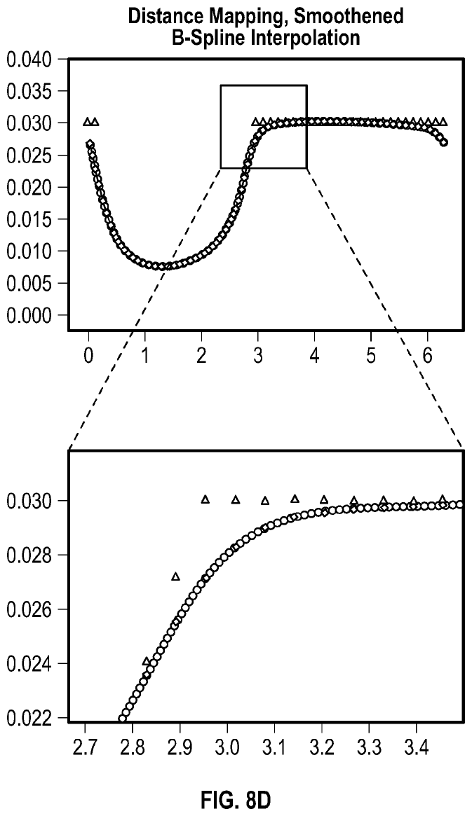

FIGS. 8A-8D illustrates an example trajectory modification process, described in the method of FIG. 8B. As illustrated in FIG. 8D, a surface feature can be identified by a boundary, indicated by points 802. In some embodiments, as illustrated in FIG. 8A, cannot be crossed by the repair trajectory. The challenge in programming a robotic surface processing unit, then, is to smoothly process an area under the red points at a distance from boundary points 802 such that a repair can occur. FIGS. 8A-8D illustrate embodiments where the repair path is a curved repair path. While it may be easy for a human to, during a repair, make a sharp curve (e.g. a 900 turn), a robotic unit incurs an acceleration penalty to do so. Additionally, causing a robotic system to stop movement and restart in a different direction may cause jerky movements. In the case of abrasive repair, it may cause surface marks to be left on a work surface. Additionally, the acceleration penalty may take more time to implement. In the example of vehicle defect repair, it is desired to repair defects as quickly as possible so that vehicles can move through the repair process quickly. A smooth repair trajectory may allow for a robotic repair to take place in a target area that, otherwise, would not be robotically processable, and additionally keep that repair within an allowable process window.

FIG. 8B illustrates a method for a trajectory modification process 850. As illustrated in block 852, the detected feature points (e.g. from method 500) are projected back into a 2D plane above the defect, as illustrated by defect points 810. The feature points, in one embodiment, are connected into feature lines. In one embodiment, this is done by considering feature points within a distance Re of each other to be considered connected.

In block 860, a set of discrete mapping points are generated M(θ)→d, where θ is an angle from a fixed axis in the 2D plane and d is the distance from the center to the nearest boundary point in the direction of θ (whether this be a point lying on the original template boundary, or on a detected feature line). This is done by discretely sampling θ and projecting rays from the repair center to the nearest boundary point. An initial trajectory 822, with an initial boundary 820, is retrieved. The trajectory 822 may be retrieved based on a number of factors, including process constraints, such as how quickly a tool or robot can move in the area of a detected surface feature. Trajectory 822 may also be retrieved based on specifications of a defect or a worksurface. For example, it may be desired to preserve orange peel on a vehicle surface, or to blend a repair area into a non-processed portion of a vehicle surface. Similarly, a trajectory 822 may be selected based on a detected surface feature.

In block 870, a transformation of trajectory parameters is completed. A trajectory, as described herein, not only includes a set of waypoints through which a surface processing tool travels, but also includes other process parameters ascribed to the tool, including an attack or contact angle, a tool speed, a robot movement speed, a force applied (or speed of adhesive or film dispensing, for example), or any other relevant process parameter such as abrasive article type or size, temperature, humidity, etc. It may be necessary to transform each of these parameters at each of the set of waypoints, which themselves may need to be transformed.

A set of mapping points is first generated marking where the outer boundary intersects the detected feature line as discussed above. In some embodiments, the mapping points go through a smoothing step (before interpolation) in which sharp “kinks” are removed (such as where the outer boundary 820 meets the feature line 810). This smoothing occurs by applying a two-step process that involves first applying gaussian filtering to the distance mapping in order to smooth edges, and second, iteratively scaling back regions of the resulting smoothened distance map that violate the original, unsmoothed boundary as gaussian filtering may induce constraint violations. For example, a violating region in the smoothed distance mapping may be iteratively scaled by an inverse bell curve until it properly conforms with the original template boundary and imposed feature lines. An inverse bell curve is modeled by Equation 6:

$$P = 1 - \frac{{e}^{( - m {t}^{2} )}}{d} \qquad Equation 6$$

In Equation 6, m and d are a tunable parameters controlling the general shape of the bell curve and t is the angular distance from an identified constraint violation at which the coefficient p is applied. In this example, when scaling back a point in the distance mapping, the radial direction of the mapping point is left unchanged.

The result is a smooth set of mapping points that lie within the original boundary constraints defined by the initial template and detected surface feature.

These mapping points are then interpolated. This interpolation could be done with linear segments, or via a spline. A B-Spline has been used herein to perform mapping point interpolation. However, it is expressly contemplated that other methods are possible. The result is now a continuous, smooth, outer mapping boundary function that yields the maximum distance allowable given any angle θ.

The smooth mapping boundary can then be used to map a set of waypoints to lie on one side of the feature line. This is done, in one embodiment, by proportionally scaling the distance a waypoint lies from the defect by a factor of d/r where d is a sampled distance on the outer mapping boundary function (at the same angle as the original, untransformed point) and r is the radius of the untransformed template mapping (820).

The transformation of a trajectory shape, or other parameters, may be linear or nonlinear. For example, a linear transformation of a trajectory shape may simply shrink or stretch a repair. A nonlinear transformation of a trajectory shape may distort the repair as to conform around an edge.

For other process parameters, similar transformation processes may be done. For example, the force applied at any given waypoint may also scale by d/r as well, or a ramp function like that described in the Examples may be applied.

The transformation step of block 870 may also include an energy minimization method, such as a potential field method. In one energy minimization method, “virtual springs” are assigned between a mesh of mapping points that cover the repair template. The mesh of points is then subjected to a forcing function that gradually shifts it away from the keep out regions (e.g., the left side of the circular repair illustrated herein). Other forces may likewise be applied such as those that generally keep the mesh centered over the defect, for example. As points are allowed to shift under the influence of these forces, the virtual springs assigned between mesh points act to stabilize the mesh, preserving mesh topology during transformation. Once these mapping points have moved to be on one side of a feature line, they can be used to map other points from the untransformed shape to take on the general shape of the transformed mapping.

Described herein are systems and methods that focus on adjusting a trajectory. However, it is expressly contemplated that a movement path is only one part of a surface processing operation. In the example of defect repair, the velocity of the robot, rotational (and/or vibrational) speed of a tool, attack angle and applied force are all also important for accomplishing a quality repair. In fact, force and velocity may be more important for repair quality than trajectory alone. As illustrated in block 880, the interpolation step 870 may be repeated for each process limitation. However, some of these parameters may be interrelated. For example, force and velocity may be mapped together

Additionally, described herein are systems and methods that envision going forward with a calculated trajectory. However, it is expressly contemplated that, while systems and methods herein increase the ability of a robotic repair unit to conduct surface processing operations on a variety of surface topographies, there may still be areas where method 850 fails to generate a trajectory that meets all set constraints. An indication that the target area is a “no go” or a non-robotically repairable area may then be returned.

FIGS. 8A-8D illustrate a method of generating a repair trajectory that avoids a surface boundary. However, it is expressly contemplated, as described in FIGS. 7A-7C, that a repair trajectory may cross or encompass a surface feature detected on a surface topography.

In block 895, a repair point is mapped by computing the (θ) at which it lies using the arctan of its coordinates. The fit b-spline is evaluated at that (θ) to get the distance mapping value d. The repair point is then scaled towards the center of the defect by a factor of d/r where r is the radius of the unmapped template.

In the specific example illustrated in FIGS. 8A, 8C and 8D, a 1D gaussian filter is applied to smooth the transition between a boundary 820 and intersection with feature 810. In this specific example, smoothing occurs after map generation and before constraint satisfaction/map scaling. This gives a smoother mapping for sample mapping points 832. While a 1D gaussian filter is described, other smoothing operations may be done. Additionally, smoothing may be done in a different order, or multiple times. In the illustrated example, smoothing is done to scale back resultant mapping to be within desired boundaries, e.g. on one side of the surface boundary. This can be done by repeatedly multiplying the smoothed distance map with the inverse bell curve 840 of FIG. 8C at regions that violate constraints. As illustrated in FIG. 8D, an interpolating B-spline is then fit through the smoothened point map to create a smooth, continuous representation of the discrete mapping.

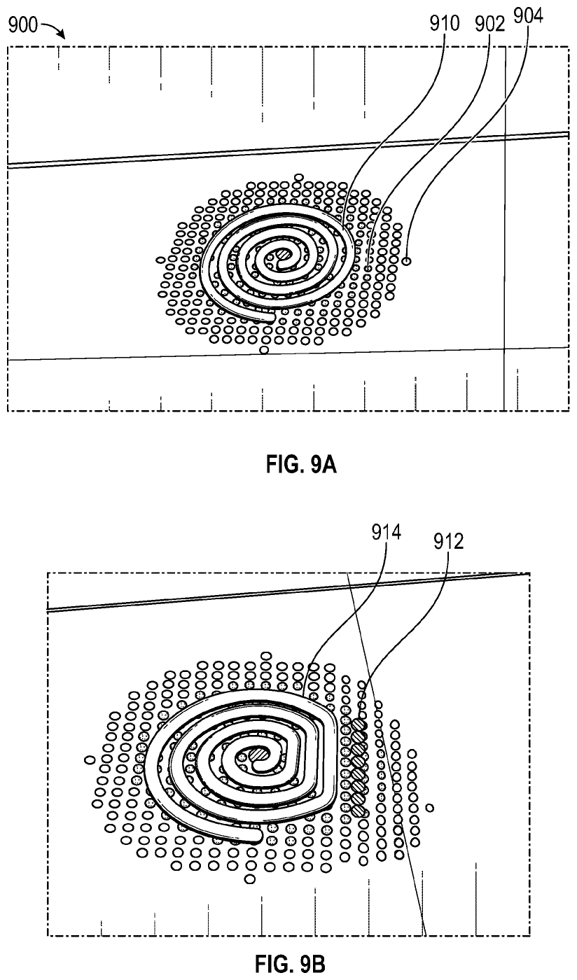

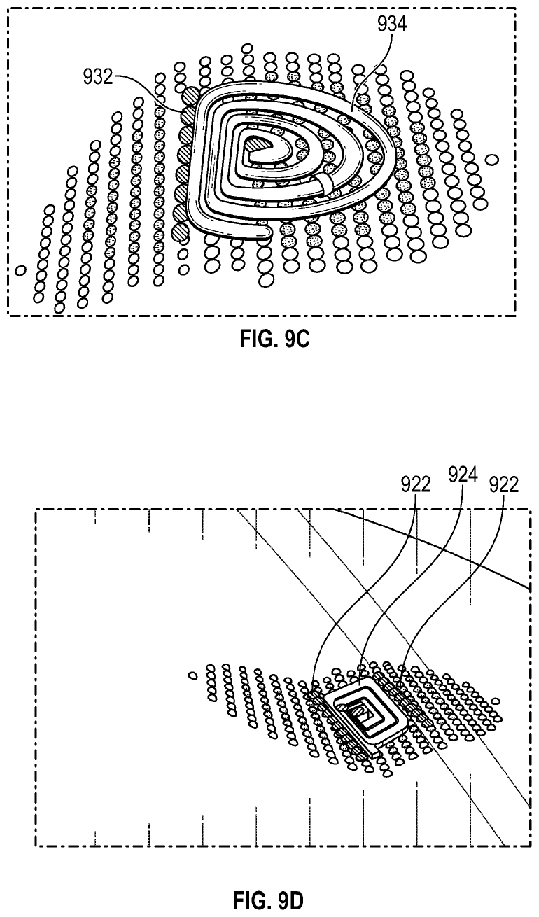

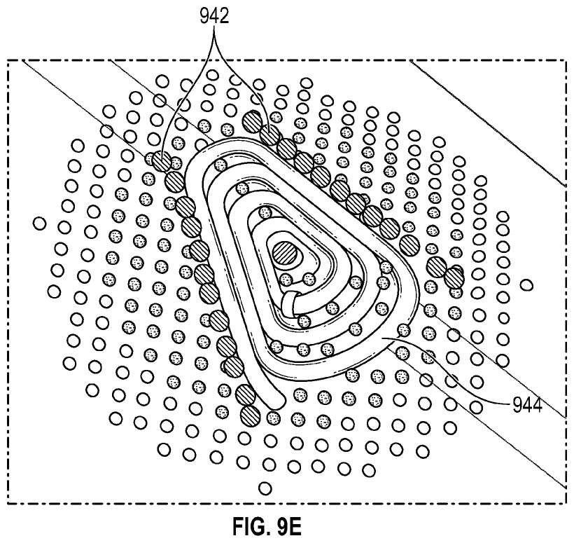

FIG. 9 illustrate modified trajectories in accordance with embodiments herein. FIG. 9A illustrates a trajectory 910 aligned on a mapped portion of a worksurface 900.

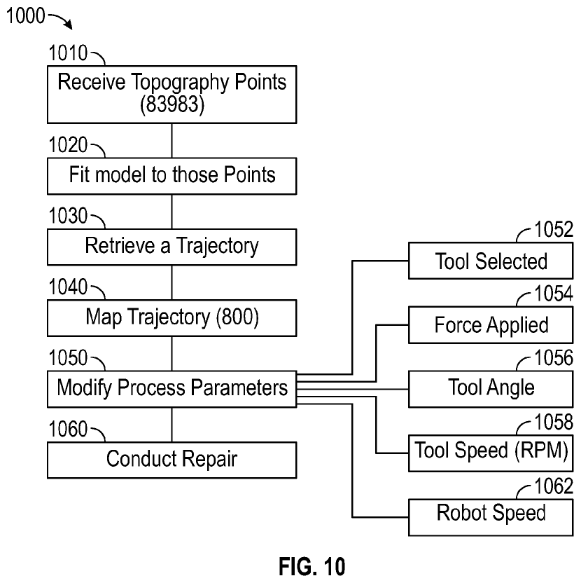

FIG. 10 illustrates a method of modifying a repair strategy in accordance with embodiments herein. As discussed in greater detail in U.S. Provisional Application No. 63/203,407, filed Jul. 21, 2021, a number of surface points are sampled and a patching is done so that they overlap. Edges can be detected anywhere the patches have been fit. A patched area 912, in some embodiments, include the repair trajectory 910. An outskirt area 904 may include sampled areas with no patching or no mathematical model fit. Outskirt area 904 may provide perimeter data that helps understand the patched area 912 better. Any analytical model may be used, such as linear, nonlinear, fitting a spline surface, or another suitable model.

FIGS. 9B-9E illustrate a modified trajectory, for example modified according to the method described in the method of FIG. 8B, based on detected surface features, for example detected using the method of FIG. 5. FIG. 9B illustrates a trajectory 914 that is near a surface feature 912. FIG. 9C illustrates a trajectory 934 that abuts a feature 932. FIG. 9D illustrates a trajectory 924 modified to address a defect between two surface features 922. FIG. 9E also illustrates a trajectory 942 between two features 944.

FIG. 10 illustrates a method of generating a modified surface processing strategy in accordance with embodiments herein. Method 1000 is described in the context of repairing a defect on a worksurface for the purposes of understanding only, and applies to other surface processing operations such as material removal, adhesive dispensing, film wrapping, etc. Method 1000 may be conducted by a robot controller locally, or may be conducted by a surface processing module in a cloud server that sends a trajectory with process parameters to the robotic controller to implement.

In block 1010, a set of topography points is received. The point cloud may be received from a vision system, in some embodiments.

In block 1020, a model is applied to these points, for example, using method 500. These points may include indications of where surface features are detected near a detected defect.

In block 1030, a trajectory template is received. The trajectory template may be received from a trajectory database, for example. In some embodiments, the retrieved trajectory includes a repair plan of forces, angles and speeds to apply at points on the trajectory. In other embodiments, repair plan parameters are independently selected based on the modified trajectory.

In block 1040, the trajectory is mapped to the defect based on the detected surface features, for example as described and illustrated in FIG. 8.

In block 1050, process parameters are selected for the trajectory. Process parameters may be assigned on the basis of discrete points along the mapped trajectory, or may be assigned based on another method. A number of process parameters are available for modification to address both the defect and any detected surface features. A tool selection 1052 can be adjusted, e.g. a size or type of an abrasive article. An applied force 1054 can be increased or decreased. An attack angle 1056 of a tool can be increased or decreased. A rotational speed 1058 of the tool can be increased or decreased. And a speed 1062 of the tool through the trajectory can be increased or decreased. Each of these parameters is set for each point along the trajectory to form a repair plan.

In block 1060, the repair plan is executed by the robotic repair unit.

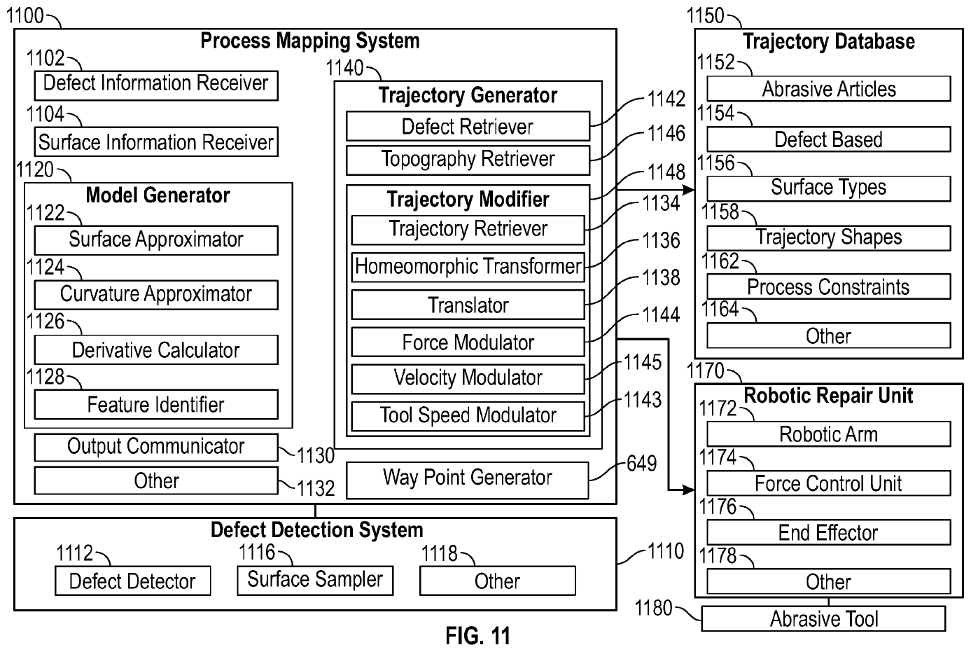

FIG. 11 illustrates a process mapping system in accordance with embodiments herein. Process mapping system 1100 may be built into a robot controller of a robotic repair unit, in some embodiments. In other embodiments, process mapping system 1100 may be remote from robotic repair unit 1170, as indicated in FIG. 11. Additionally, FIG. 11 illustrates an embodiment where trajectory database 1150 is separate and remote from process mapping system 1100, however it is expressly contemplated that process mapping system 600 may be located on a sever with trajectory database 1150. It is expressly contemplated that other configurations of components are envisioned than those illustrated in FIG. 11.

A defect detection system 1110 detects defects on a worksurface and provides defect and surface information to process mapping system 1100. Defect detection system 1110 may be an imaging system as described with respect to FIG. 1. However, other systems 1110 may be possible. A defect detector 1112 detects defects on a worksurface, in the example of vehicle repair. However, in the embodiment of adhesive dispensing, an adhesive target area detector 1112 detects or specifies where adhesive should be dispensed. In the embodiment of material removal, a target removal area 1112 detects where material should be removed from a surface. A surface sampler 1116 samples a surface around the detected defect/adhesive dispensing target/target removal area. Defect detection system 1110 may include other functionality 1118 as well. For example, defect detection system 1110 may be a camera system that images a surface before and after a defect removal/adhesive dispensation/material removal operation.

A robotic repair unit 1170 is the mechanical unit responsible for implementing the repair trajectory on a worksurface. The robotic repair unit 1170 includes a robotic arm 1172 that moves abrasive tool 1180 into position for a repair operation. Robotic arm 1172 may have multiple movement mechanisms, motor-powered or otherwise, that move abrasive tool 1180 through a trajectory, as illustrated in FIGS. 7-9. Robotic repair unit 1170 may also include a force control unit 1174 that applies force through an end effector to the abrasive tool 1180.

A defect information receiver 1102 retrieves information about a defect, such as from defect detection system 1110. Defect information retriever 1102 may retrieve a defect location, with respect to a CAD model, or may receive other location information.

Surface information retriever 1104 retrieves surface sampling information retrieved by surface sampler 1116. Based on retrieved surface sampling, model generator 1120 can generate a mathematical model to approximate the curvature and detect surface features near the defect. A surface approximator 1122 approximates the surface. This may be done using a polynomial approximation, an approximation using a splines surface or another suitable approximation. Based on the surface approximation, a curvature approximator 1124 determines a magnitude and direction of curvature at each of the sampled points. A derivative calculator 1126 calculates a derivative of the curvature along the surface. Based on the derivative calculations, feature identifier 1128 identifies a set of feature points, for example an edge, a concave curve, a convex curve, or another feature.

A trajectory generator 1140 generates a modified trajectory based on surface curvature. A defect retriever 642 retrieves information about a defect, for example from defect detection system 1110. Retrieved defect information may include a defect type, size, location, severity or other information that may be useful for choosing a trajectory template. Feature retriever 1146 retrieves information from feature identifier about any identified features near a defect that may interfere with a defect repair.

A trajectory modifier 1148 modifies a trajectory template based on known information about a defect, from defect retriever 1142, and known information about surface features, from feature retriever 1146. A trajectory retriever 1134 may retrieve a trajectory template from trajectory database 1150. Trajectory database 1150 may include a number of trajectories that may be selected based on defect parameters, as indicated in block 1154, such as a defect type, defect location, defect size, defect severity, etc. A trajectory may also be selected based on an abrasive article 1152 or tool selected. For example, the size or type of an abrasive disc or backup pad may dictate, at least to some extent, a trajectory selection. Information about a worksurface, indicated in block 1156, such as the worksurface material (e.g. wood, plastic, metal, paint, clearcoat, layers thereof, etc.), may influence a trajectory selection. Similarly, process constraints 1162 of robotic repair unit 1170, such as a maximum force that force control unit 1174 can exert, a maximum RPM of an abrasive tool, or clearance ranges needed for different components, may influence a trajectory selection. Based on known information about a defect, surface, and robotic repair unit 1170, an initial trajectory shape may be selected from trajectory shapes 658, such as a spiral, a circle, elliptical, hypotrochoid, rosette, or other appropriate shape.

Based on all of the retrieved information, trajectory modifier 1148 modifies the received trajectory template. A homeomorphic transformer 1138 may conduct a homeomorphic transformation on the trajectory template. A translator 1138 may translate the trajectory template, or the transformed template. Similarly, a homeomorphic transformer 1138 may transform the template or a translated template. A force modulator 1144 selects a force to be applied along the trajectory. The force modulator may select forces to be applied at discrete points with smoothing between points of different force application, or may select a force profile to be applied along different portions of the trajectory template. A velocity modulator 1145 adjusts a velocity at which a tool moves through the trajectory and may be selected based on a speed the tool should travel through discrete points, an acceleration or deceleration between points, or a velocity that should be achieved at each point or along a portion of the trajectory. A tool speed modulator 1143 adjusts a speed at which the tool moves, for example rotational movement, orbital movement, vibration movement, etc.

Based on the modified trajectory, a number of waypoints may be generated, by waypoint generator 1149. Waypoints may be generated to guide robotic arm 1172 from a previous defect, or a current position, to the defect location and through the modified trajectory to complete the repair.

Systems and methods herein sample a worksurface and fit an analytical model to the sampled points. Based on detected surface features, a surface processing system generates a repair plan by generating a trajectory that incorporates known information about a defect on the worksurface and the surface topography. The repair plan also includes process variables along the trajectory based on the known defect information and the surface topography.

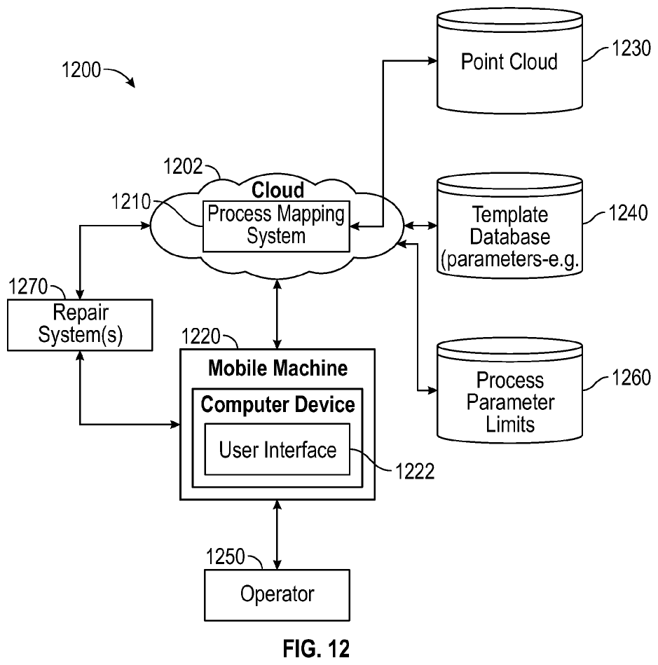

FIG. 12 is a surface process system architecture. The surface processing system architecture 800 illustrates one embodiment of an implementation of a defect detection and ranking system 1210. As an example, surface process system 1200 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-11 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 12, some items are similar to those shown in earlier figures. FIG. 12 specifically shows that a process mapping system 1210 can be located at a remote server location 1202. Therefore, computing device 1220 accesses those systems through remote server location 1202. Operator 1250 can use computing device 1220 to access user interfaces 1222 as well.

FIG. 12 shows that it is also contemplated that some elements of systems described herein are disposed at remote server location 1202 while others are not. By way of example, storage 1230, 1240 or 1260 or robotic repair systems 1270 can be disposed at a location separate from location 1202 and accessed through the remote server at location 1202. Regardless of where they are located, they can be accessed directly by computing device 1220, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

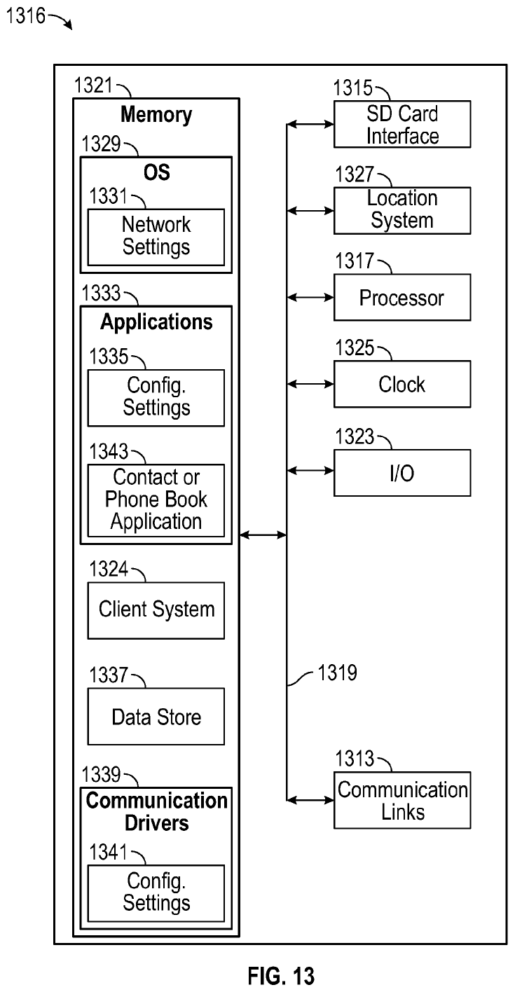

FIGS. 13-15 show examples of computing devices that can be used in embodiments shown in previous Figures.

FIG. 13 is a simplified block diagram of one illustrative example of a handheld or mobile computing device that can be used as a user's or client's handheld device 1316 (e.g., as computing device 1220 in FIG. 12), in which the present system (or parts of it) can be deployed. For instance, a mobile device can be deployed in the operator compartment of computing device 1220 for use in generating, processing, or displaying the data. FIG. 140 is another example of a handheld or mobile device.

FIG. 13 provides a general block diagram of the components of a client device 1316 that can run some components shown and described herein. Client device 1316 interacts with them, or runs some and interacts with some. In the device 1316, a communications link 1313 is provided that allows the handheld device to communicate with other computing devices and under some embodiments provides a channel for receiving information automatically, such as by scanning. Examples of communications link 1313 include allowing communication though one or more communication protocols, such as wireless services used to provide cellular access to a network, as well as protocols that provide local wireless connections to networks.

In other examples, applications can be received on a removable Secure Digital (SD) card that is connected to an interface 1315. Interface 1315 and communication links 1313 communicate with a processor 1317 (which can also embody a processor) along a bus 1319 that is also connected to memory 1321 and input/output (I/O) components 1323, as well as clock 1325 and location system 1327.

I/O components 1323, in one embodiment, are provided to facilitate input and output operations and the device 1316 can include input components such as buttons, touch sensors, optical sensors, microphones, touch screens, proximity sensors, accelerometers, orientation sensors and output components such as a display device, a speaker, and or a printer port. Other I/O components 1323 can be used as well.

Clock 1325 illustratively comprises a real time clock component that outputs a time and date. It can also provide timing functions for processor 1317.

Illustratively, location system 1327 includes a component that outputs a current geographical location of device 1316. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1321 stores operating system 1329, network settings 1331, applications 1333, application configuration settings 1335, data store 1337, communication drivers 1339, and communication configuration settings 1341. Memory 1321 can include all types of tangible volatile and non-volatile computer-readable memory devices. It can also include computer storage media (described below). Memory 1321 stores computer readable instructions that, when executed by processor 1317, cause the processor to perform computer-implemented steps or functions according to the instructions. Processor 1317 can be activated by other components to facilitate their functionality as well.

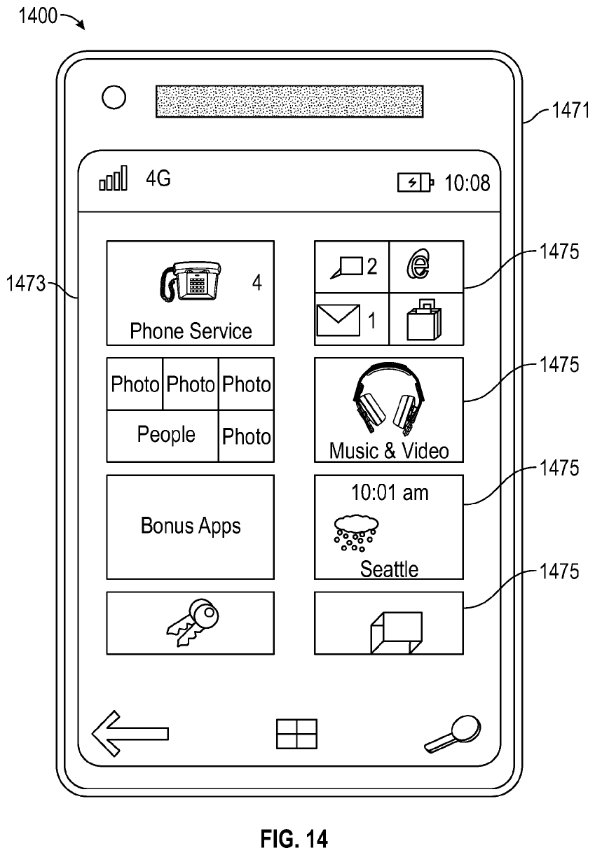

FIG. 14 shows that the device can be a smart phone 1401. Smart phone 1471 has a touch sensitive display 1473 that displays icons or tiles or other user input mechanisms 1475. Mechanisms 1475 can be used by a user to run applications, make calls, perform data transfer operations, etc. In general, smart phone 1471 is built on a mobile operating system and offers more advanced computing capability and connectivity than a feature phone.

Note that other forms of the devices 1416 are possible.

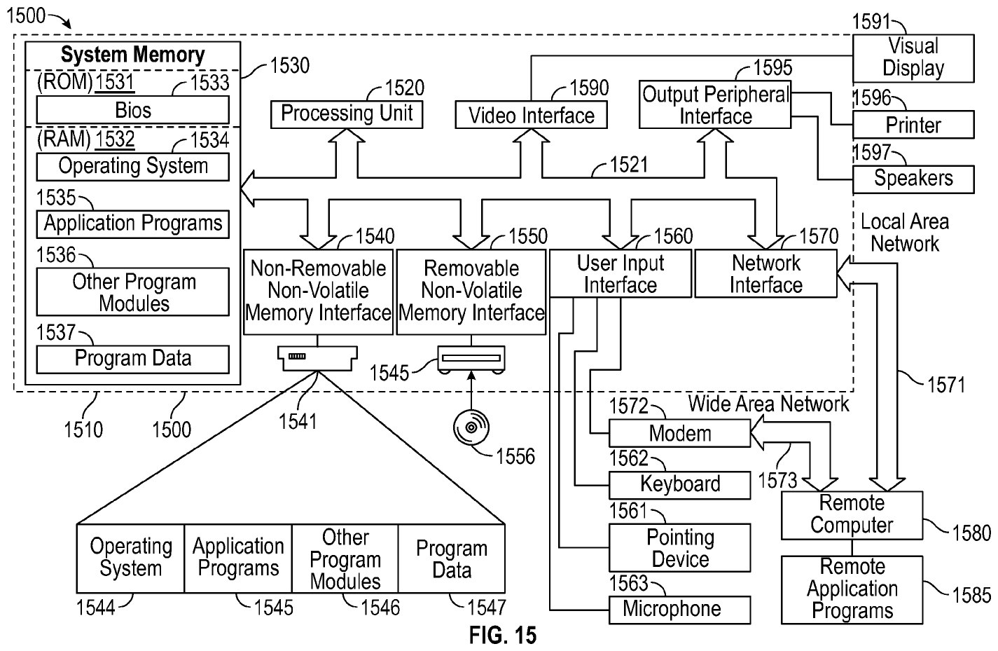

FIG. 15 is a block diagram of a computing environment that can be used in embodiments shown in previous Figures.

FIG. 15 is one example of a computing environment in which elements of systems and methods described herein, or parts of them (for example), can be deployed. With reference to FIG. 15, an example system for implementing some embodiments includes a general-purpose computing device in the form of a computer 1510. Components of computer 1510 may include, but are not limited to, a processing unit 1520 (which can comprise a processor), a system memory 1530, and a system bus 1521 that couples various system components including the system memory to the processing unit 1520. The system bus 1521 may be any of several types of bus structures including a memory bus or memory controller, a peripheral bus, and a local bus using any of a variety of bus architectures. Memory and programs described with respect to systems and methods described herein can be deployed in corresponding portions of FIG. 15.

Computer 1510 typically includes a variety of computer readable media. Computer readable media can be any available media that can be accessed by computer 1510 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1510. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1530 includes computer storage media in the form of volatile and/or nonvolatile memory such as read only memory (ROM) 1531 and random access memory (RAM) 1532. A basic input/output system 1533 (BIOS) containing the basic routines that help to transfer information between elements within computer 1510, such as during start-up, is typically stored in ROM 1531. RAM 1532 typically contains data and/or program modules that are immediately accessible to and/or presently being operated on by processing unit 1520. By way of example, and not limitation, FIG. 15 illustrates operating system 1534, application programs 1535, other program modules 1536, and program data 1537.

The computer 1510 may also include other removable/non-removable and volatile/nonvolatile computer storage media. By way of example only, FIG. 15 illustrates a hard disk drive 1541 that reads from or writes to non-removable, nonvolatile magnetic media, nonvolatile magnetic disk 1552, an optical disk drive 1555, and nonvolatile optical disk 1556. The hard disk drive 1541 is typically connected to the system bus 1521 through a non-removable memory interface such as interface 1540, and optical disk drive 1555 are typically connected to the system bus 1521 by a removable memory interface, such as interface 1550.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 15, provide storage of computer readable instructions, data structures, program modules and other data for the computer 1510. In FIG. 15, for example, hard disk drive 1541 is illustrated as storing operating system 1544, application programs 1545, other program modules 1546, and program data 1547. Note that these components can either be the same as or different from operating system 1534, application programs 1535, other program modules 1536, and program data 1537.

A user may enter commands and information into the computer 1510 through input devices such as a keyboard 1562, a microphone 1563, and a pointing device 1561, such as a mouse, trackball or touch pad. Other input devices (not shown) may include a joystick, game pad, satellite receiver, scanner, or the like. These and other input devices are often connected to the processing unit 1520 through a user input interface 1560 that is coupled to the system bus, but may be connected by other interface and bus structures. A visual display 1591 or other type of display device is also connected to the system bus 1521 via an interface, such as a video interface 1590. In addition to the monitor, computers may also include other peripheral output devices such as speakers 1597 and printer 1596, which may be connected through an output peripheral interface 1595.

The computer 1510 is operated in a networked environment using logical connections, such as a Local Area Network (LAN) or Wide Area Network (WAN) to one or more remote computers, such as a remote computer 1580.

When used in a LAN networking environment, the computer 1510 is connected to the LAN 1571 through a network interface or adapter 1570. When used in a WAN networking environment, the computer 1510 typically includes a modem 1572 or other means for establishing communications over the WAN 1573, such as the Internet. In a networked environment, program modules may be stored in a remote memory storage device. FIG. 15 illustrates, for example, that remote application programs 1585 can reside on remote computer 1580.

A robotic system is presented that includes a surface inspection system that receives sampling information for a number of areas within a region of a worksurface. The system also includes a robotic arm, coupled to a surface engaging tool, the robotic repair arm being configured to cause the surface processing tool to engage the region of the worksurface. The system also includes a process mapping system configured to, based on the sampling information: approximate a surface topography in the region of the worksurface, generate a surface processing plan for the region based on the approximated surface topography that includes a trajectory. The surface processing plan includes one of: a force profile along the trajectory, a velocity profile for the surface engaging tool along the trajectory, a rotational speed profile, for the surface engaging tool, along the trajectory, or a trajectory modification that accounts for the presence of a surface feature identified in the approximated surface topography. The process mapping system is also configured to generate a control signal for the robotic arm that includes the surface processing plan.

The system may be implemented such that the surface processing plan includes a trajectory modification that accounts for the presence of a surface feature identified in the approximated surface topography, wherein the surface feature includes a concave surface, a convex surface or an edge within the region.

The system may be implemented such the surface processing plan includes an attack angle profile for the surface engaging tool along the trajectory.

The system may be implemented such the surface processing plan includes a trajectory modification that accounts for the presence of a surface feature identified in the approximated surface topography. The trajectory modification includes a homeomorphic transformation of a trajectory template.

The system may be implemented such the surface processing plan includes a trajectory modification that accounts for the presence of a surface feature identified in the approximated surface topography. The trajectory modification includes a discontinuous trajectory.

The system may be implemented such the discontinuous trajectory skips over an identified surface feature.

The system may be implemented such the transformation stretches the trajectory over an identified surface feature.

The system may be implemented such the transformation moves the trajectory away from an identified surface feature.

The system may be implemented such the trajectory has a perimeter with a shape, and wherein the transformation changes the shape.

The system may be implemented such the shape is stretched from a first shape to a second shape.

The system may be implemented such the shape is compressed from a first shape to a second shape.

The system may be implemented such a portion of the shape is compressed.

The system may be implemented such the compression avoids an identified surface feature.

The system may be implemented such the compression avoids a boundary around the identified surface feature.

The system may be implemented such a portion of the shape is stretched.

The system may be implemented such the stretching extends over an identified surface feature.

The system may be implemented such the worksurface is a vehicle.

The system may be implemented such the surface inspection system includes a vision system.

The system may be implemented such the vision system includes a camera.

The system may be implemented such the region contains a defect, and wherein the surface engaging tool is a material removal tool.

The system may be implemented such the surface processing tool is a sander or polishing tool.

The system may be implemented such the surface processing plan includes a trajectory modification that accounts for the presence of a surface feature identified in the approximated surface topography, wherein the process mapping system identifies the surface feature by: mapping each of the sampled areas in the region, approximating curvature at each of the sampled areas in the region, calculating the derivative of the approximated curvature at each of the sampled areas, and identifying the surface feature in the region based on the derivative calculation.

The system may be implemented such the trajectory includes a series of waypoints through the region.

The system may be implemented such the trajectory template is selected based on a defect size, defect location, defect type or defect severity.

The system may be implemented such the surface processing plan includes a trajectory modification that accounts for the presence of a surface feature identified in the approximated surface topography, wherein the trajectory modification is based on the identified surface feature.

The system may be implemented such the trajectory is stretched or compressed.

The system may be implemented such the trajectory shape is a circle, oval, rosette, spiral or hypotrochoid.

The system may be implemented such the trajectory is proportionately enlarged or reduced.

The system may be implemented such the trajectory modification includes a modified tool force, disk speed, or tool speed.

The system of claim 1, wherein the robotic arm executes the control signal and follows the trajectory.

The system of claim 22, wherein the approximated curvature is a polynomial approximation, a spline surface, or a support vector machine.

The system may be implemented such the approximated curvature is a polynomial approximation that includes patches of polynomials.

The system may be implemented such the surface processing plan includes a trajectory modification that accounts for the presence of a surface feature identified in the approximated surface topography, wherein the trajectory modification includes: mapping a trajectory template boundary to lie on one side of an identified surface boundary within the surface topography, interpolating the mapped trajectory, and mapping a plurality of waypoints from the mapped trajectory.

The system may be implemented such mapping includes fitting a spline to the plurality of waypoints to make a continuous path.

The system may be implemented such the interpolation includes a B-spline interpolation, a quadradic interpolation, a cubic interpolation, a quintic interpolation, a NURB interpolation, piecewise continuous spline interpolation, poly-chain interpolation.

The system may also include a smoothing step.

The system may be implemented such the smoothing step applies a gaussian filter.

The system may be implemented such a second smoothing is applied, and wherein the second smoothing includes multiplying the mapped trajectory with an inverse bell curve.

The system may be implemented such the identified surface boundary is a constraining feature.

The system may be implemented such the identified surface boundary includes a surface feature and a buffer space from the surface feature.

The system may be implemented such the trajectory template has a perimeter, and wherein mapping the trajectory template includes mapping the perimeter to the identified surface boundary.

The system may be implemented such the surface processing plan includes a trajectory modification that accounts for the presence of a surface feature identified in the approximated surface topography, wherein identifying the surface feature includes an energy minimization method.

The system may be implemented such the energy minimization method includes a potential field method, a, or a snake interpolation.

The system may be implemented such the method includes a dynamic energy minimization smoothing step, and wherein a penalty is assigned during the dynamic energy minimization smoothing step for crossing a boundary of the surface feature.

A repair plan generation system for a defect on a worksurface is presented that includes a surface sampling receiver that receives a surface topography of the worksurface, a defect indication receiver that receives an indication of a defect on the worksurface, a process constraint receiver that receives parameter constraints for a robotic repair unit, a trajectory modifier that modifies a trajectory template. The trajectory modifier includes a transformer that transforms the trajectory template into a transformed trajectory, based on the surface topography. The system also includes a repair plan generator that generates a repair plan based on the transformed trajectory and includes, along the transformed trajectory, sets process conditions. The repair plan generator includes a force modulator that sets an applied force of a tool on the worksurface, a velocity modulator that sets a velocity at which the tool moves across the worksurface, a tool speed modulator that sets a rotational speed of the tool, and a control signal generator that communicates the generated repair plan to a robot controller that automatically implements the repair plan and completes a defect repair based on the repair plan.

The system may be implemented such the transformed trajectory is spaced apart from the surface feature by a boundary.

The system may be implemented such the transformed trajectory is translated.

The system may be implemented such the transformed trajectory is off-center from the defect.

The system may be implemented such the transformer: projects the surface feature into a 2-dimensional plane, maps the trajectory template to a boundary, transforms the mapped trajectory template, wherein transforming includes modifying a trajectory parameter, and mapping the transformed trajectory to the surface topography, resulting in the transformed trajectory.

The system may include smoothing the interpolated trajectory.

The system may also include iteratively smoothing the interpolated trajectory until a constraint is met.

The system may be implemented such the constraint is a surface boundary within the surface topography.

The system may be implemented such the indication of the surface feature is generated by a surface model generator that includes: a surface approximator that approximates the surface at each of the plurality of surface samples using an approximation, a curvature approximator that approximates the curvature and derivative of curvature at each of the plurality of surface samples, and a feature detector that, based on a derivative of the curvature approximation at each of the surface samples, identifies a point of zero curvature as the surface feature.

The system may be implemented such the plurality of surface samples are received from a CAD model.

The system may be implemented such the plurality of surface samples are received from a surface measurement system.

The system may be implemented such the surface measurement system includes a camera.

The system may be implemented such the approximation is a polynomial approximation.

The system may be implemented such the polynomial approximation is a cubic polynomial.

The system may be implemented such the plurality of surface samples are within a radius of the defect.

The system may be implemented such the worksurface is a vehicle surface, and wherein the surface feature is a concave surface, convex surface or edge on the vehicle surface proximate the defect.

The system may be implemented such the plurality of surface samples are received from a vision system that images the worksurface.

The system may also include an attack angle modulator that sets an attack angle of the tool.

The system may be implemented such the modified trajectory includes a discontinuous trajectory.

The system may be implemented such the discontinuous trajectory skips over an identified surface feature.

The system may be implemented such the transformation stretches the trajectory over an identified surface feature.

The system may be implemented such the transformation moves the trajectory away from an identified surface feature.

The system may be implemented such the trajectory has a perimeter with a shape, and wherein the transformation changes the shape.

The system may be implemented such the shape is stretched from a first shape to a second shape.

The system may be implemented such the shape is compressed from a first shape to a second shape.

The system may be implemented such a portion of the shape is compressed.

The system may be implemented such the compression avoids an identified surface feature.

The system may be implemented such the compression avoids a boundary around the identified surface feature.

The system may be implemented such a portion of the shape is stretched.

The system may be implemented such the stretching extends over an identified surface feature.

The system may be implemented such the worksurface is a vehicle.

The system may be implemented such the surface sampling receiver receives surface samples from a vision system.

The system may be implemented such the vision system includes a camera.

The system may be implemented such the tool is a sander or polishing tool.

The system may be implemented such the trajectory template is selected based on a defect size, defect location, defect type or defect severity.

The system may be implemented such the trajectory template has a shape, and wherein the shape is a circle, oval, rosette, spiral or hypotrochoid.

The system may be implemented such modifying the trajectory includes: mapping a trajectory template boundary to lie on one side of an identified surface boundary within the surface topography, interpolating the mapped trajectory, and mapping a plurality of waypoints from the mapped trajectory.

The system may be implemented such mapping includes fitting a spline to the plurality of waypoints to make a continuous path.

The system may be implemented such the interpolation includes a B-spline interpolation, a quadradic interpolation, a cubic interpolation, a quintic interpolation, a NURB interpolation, piecewise continuous spline interpolation, poly-chain interpolation.

The system may also include a smoothing step.

The system may be implemented such the smoothing step applies a gaussian filter.

The system may be implemented such a second smoothing is applied, and wherein the second smoothing includes multiplying the mapped trajectory with an inverse bell curve.

The system may be implemented such the identified surface boundary is a constraining feature.

The system may be implemented such the identified surface boundary includes a surface feature and a buffer space from the surface feature.

The system may be implemented such approximating the surface includes an energy minimization method.

The system may be implemented such the energy minimization method includes a potential field method or a snake interpolation.

The system may be implemented such the method includes a dynamic energy minimization smoothing step, and wherein a penalty is assigned during the dynamic energy minimization smoothing step for crossing a boundary of a surface feature.

The system may be implemented such the approximation is a polynomial approximation, a spline surface, or a support vector machine.

The system may be implemented such the polynomial approximation includes patches of polynomials.

A method of removing material from a worksurface is presented that includes identifying a target area on the worksurface for material removal, sampling a surface around the target area on the worksurface, modeling the surface and, based on the model, detecting a surface topography, modifying a surface processing trajectory, using a transformer, based on the detected surface topography, wherein the transformed surface processing trajectory includes a continuous curve through a series of waypoints, and generating a repair plan including, at each of the waypoints: an applied force, a velocity, a rotational tool speed of a tool, and a tool angle with respect to the worksurface. The method also includes transmitting a control signal to a robotic material removal system, wherein the control signal includes the repair plan.

The method may be implemented such the transformer transforms the surface processing trajectory by: projecting the surface processing trajectory into a 2-dimensional plane, mapping the surface process trajectory to a surface boundary within the surface topography, transforming the mapped surface process trajectory, and mapping the interpolated trajectory to a surface topography of the worksurface to obtain the transformed surface processing trajectory.

The method may also include smoothing the mapped surface process trajectory.

The method may be implemented such smoothing includes applying a Gaussian filter.

The method may be implemented such interpolating includes applying a linear interpolation.

The method may be implemented such the linear interpolation includes a B-spline interpolation, a quadradic interpolation, a cubic interpolation, a quintic interpolation, a NURB interpolation, piecewise continuous spline interpolation, poly-chain interpolation.

The method may be implemented such modeling the surface includes: approximating the surface at each of a plurality of sampled surface locations, approximating the curvature at each of the sampled surface locations, and detecting a surface feature based on a derivative of the approximated curvature.

The method may be implemented such the surface approximation is a polynomial approximation, a linear regression approximation, or a least squares approximation.

The method may be implemented such the target area includes a defect.

The method may be implemented such the worksurface includes a vehicle.

The method may be implemented such sampling a surface includes a vision system imaging the surface.

The method may be implemented such the vision system includes a camera.

The method may be implemented such the surface processing trajectory includes a movement path through the target area.

The method may be implemented such the applied force at each of the waypoints is a modified applied force, modified by a force modifier based on the surface topography.

The method may be implemented such the velocity at each of the waypoints is a modified velocity, modified by a velocity modifier based on the surface topography.

The method may be implemented such the rotational tool speed at each of the waypoints is a modified rotational tool speed, modified by a rotational tool speed modifier based on the surface topography.

The method may be implemented such the tool angle at each of the waypoints is a modified tool angle, modified by a tool angle modifier based on the surface topography.

The method may be implemented such modifying the surface processing trajectory includes a homeomorphic transformation of a trajectory template.

The method may be implemented such the modified trajectory includes a discontinuous trajectory.

The method may be implemented such the discontinuous trajectory skips over an identified surface feature.

The method may be implemented such the transformation stretches the trajectory over an identified surface feature.

The method may be implemented such the transformation moves the trajectory away from an identified surface feature.

The method may be implemented such the trajectory has a perimeter with a shape, and wherein the transformation changes the shape.

The method may be implemented such the shape is stretched from a first shape to a second shape.

The method may be implemented such the shape is compressed from a first shape to a second shape.

The method may be implemented such a portion of the shape is compressed.

The method may be implemented such the compression avoids an identified surface feature.

The method may be implemented such the compression avoids a boundary around the identified surface feature.

The method may be implemented such a portion of the shape is stretched.

The method may be implemented such the stretching extends over an identified surface feature.

The method may be implemented such the shape is a circle, oval, rosette, spiral or hypotrochoid.

The method may be implemented such the trajectory template is selected based on a defect size, defect location, defect type or defect severity.

The method may be implemented such the trajectory is modified based on the identified surface feature.

The method may be implemented such the surface approximation is a polynomial approximation, a spline surface, or a support vector machine.

The method may be implemented such the polynomial approximation includes patches of polynomials.

The method may be implemented such the trajectory template has a perimeter, and wherein mapping the trajectory template includes mapping the perimeter to the identified surface boundary.

The method may be implemented such approximating the surface includes an energy minimization method.

The method may be implemented such the energy minimization method includes a potential field method, a, or a snake interpolation.

The method may be implemented such the method includes a dynamic energy minimization smoothing step, and wherein a penalty is assigned during the dynamic energy minimization smoothing step for crossing a boundary of a surface feature.

The method may be implemented such the tool is a sander or polishing tool.

A robotic surface processing system is presented that includes a surface inspection system that receives sampling information for a number of areas within a region of a worksurface to approximate a surface topography within the region. The system also includes a robotic arm, coupled to a surface engaging tool, the robotic repair arm being configured to cause the surface processing tool to contact the region of the worksurface. The system also includes a process mapping system configured to: identify a surface constraining feature within the region, generate a surface processing plan for the region based on the identified surface constraining feature that includes a trajectory. The surface processing plan includes one of: a force profile along the trajectory, a velocity profile for the surface engaging tool along the trajectory, a rotational speed profile, for the surface engaging tool, along the trajectory or a trajectory modification that accounts for the surface constraining feature. The system is configured to generate a control signal for the robotic arm that includes the surface processing plan.

The system may be implemented such the surface processing plan includes an attack angle profile for the surface engaging tool along the trajectory.

The system may be implemented such the surface processing plan includes a trajectory modification that accounts for the surface constraining feature. The trajectory modification includes a homeomorphic transformation of a template trajectory.

The system may be implemented such the surface processing plan includes a trajectory modification that accounts for the surface constraining feature. The trajectory modification includes a discontinuous trajectory.

The system may be implemented such the discontinuous trajectory skips over the surface constraining feature.

The system may be implemented such the transformation stretches the trajectory over the surface constraining feature.

The system may be implemented such the transformation moves the trajectory away from the surface constraining feature.

The system may be implemented such the template trajectory has a perimeter with a shape, and wherein the transformation changes the shape.

The system may be implemented such the shape is stretched from a first shape to a second shape.

The system may be implemented such the shape is compressed from a first shape to a second shape.

The system may be implemented such a portion of the shape is compressed.

The system may be implemented such the compression avoids an identified surface feature.

The system may be implemented such the compression avoids a boundary around the identified surface feature.

The system may be implemented such a portion of the shape is stretched.

The system may be implemented such the stretching extends over an identified surface feature.

The system may be implemented such the worksurface is a vehicle.

The system may be implemented such the region contains a defect, and wherein the surface engaging tool is a material removal tool.

The system may be implemented such the surface processing tool is a sander or polishing tool.

The system may be implemented such the surface inspection system includes a vision system.

The system may be implemented such the vision system includes a camera.

The system may be implemented such the process mapping system identifies a surface constraining feature by: approximating each of the sampled areas in the region, approximating curvature at each of the sampled areas in the region, calculating the derivative of the approximated curvature at each of the sampled areas, and identifying the surface constraining feature in the region based on the derivative calculation.

The system may be implemented such the trajectory includes a series of waypoints through the region.

The system may be implemented such the template trajectory is selected based on a defect size, defect location, defect type or defect severity.

The system may be implemented such the trajectory is modified based on the identified surface feature.

The system may be implemented such the trajectory is stretched or compressed.

The system may be implemented such the shape is a circle, oval, rosette, spiral or hypotrochoid.

The system may be implemented such the robotic arm executes the control signal and follows the path.

The system may be implemented such the approximation of the sampled areas is a polynomial approximation.

The system may be implemented such the polynomial approximation is a cubic polynomial.

The system may be implemented such the surface processing plan includes a trajectory modification that accounts for the surface constraining feature, wherein the trajectory modification includes: mapping a trajectory template boundary to lie on one side of an identified surface boundary within the surface topography, interpolating the mapped trajectory, and mapping a plurality of waypoints from the mapped trajectory.

The system may be implemented such mapping includes fitting a spline to the plurality of waypoints to make a continuous path.

The system may be implemented such the interpolation includes a B-spline interpolation, a quadradic interpolation, a cubic interpolation, a quintic interpolation, a NURB interpolation, piecewise continuous spline interpolation, poly-chain interpolation.

The system also includes a smoothing step.

The system may be implemented such the smoothing step applies a gaussian filter.

The system may be implemented such a second smoothing is applied, and wherein the second smoothing includes multiplying the mapped trajectory with an inverse bell curve.

The system may be implemented such the identified surface boundary is the surface constraining feature.

The system may be implemented such the identified surface boundary includes a surface feature and a buffer space from the surface feature.

The system may be implemented such the trajectory template has a perimeter, and wherein mapping the trajectory template includes mapping the perimeter to the identified surface boundary.

The system may be implemented such identifying a surface constraining feature includes an energy minimization method.

The system may be implemented such the energy minimization method includes a potential field method, a, or a snake interpolation.

The system may be implemented such the method includes a dynamic energy minimization smoothing step, and wherein a penalty is assigned during the dynamic energy minimization smoothing step for crossing a boundary of the surface constraining feature.

### EXAMPLES

### Example 1

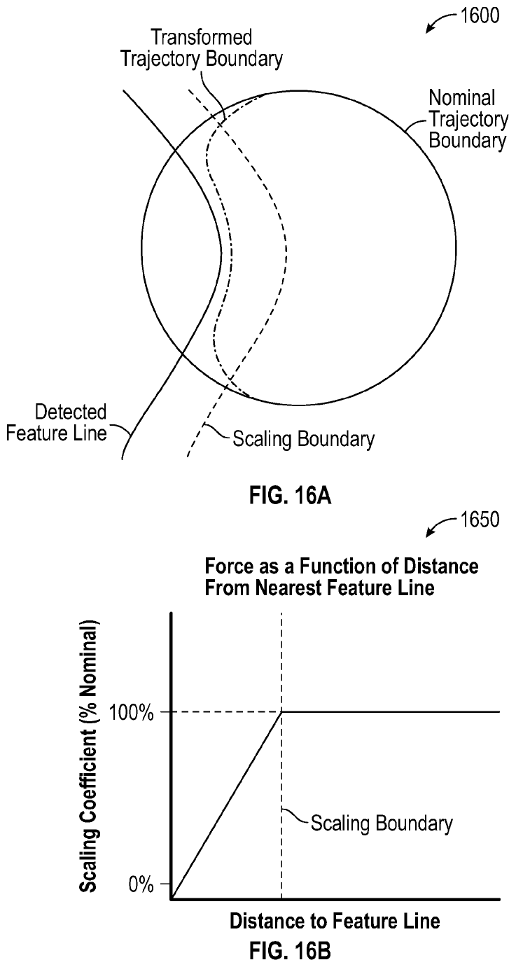

FIGS. 16A-16B illustrate an example adjustment 1600 of a trajectory. After the repair is transformed in the 2D plane, as illustrated in FIG. 16A, a force applied at each waypoint is adjusted.

For example, the force applied at or near a waypoint may be proportionally scaled down depending on how close that waypoint is to a detected feature line 1610. In this example, a nominal force value is chosen (perhaps part of the repair template chosen) for each waypoint during the repair. The distance from each waypoint to the nearest feature line is measured. Feature points falling within a predetermined distance (shown by the scaling boundary in figure X), are subject to be proportionally scaled down. This scaling could be carried out in accordance with a simple ramp function 1650 as shown in FIG. 16B.

Once forces are assigned and appropriately modified at each waypoint as described, they be interpolated to provide a continuous signal for a forcing tool to track during the repair. This interpolation may occur via linear interpolation, spline interpolation, or other method.

Example 1 illustrates the process of modifying applied force at each waypoint. This process may be repeated for other trajectory parameters, including speed, attack angle, tool rotation speed, etc.

1. A robotic system comprising:
a surface inspection system that receives sampling information for a number of areas within a region of a worksurface;
a robotic arm, coupled to a surface engaging tool, the robotic repair arm being configured to cause the surface processing tool to engage the region of the worksurface; and
a process mapping system configured to, based on the sampling information:
approximate a surface topography in the region of the worksurface;
generate a surface processing plan for the region based on the approximated surface topography that comprises a trajectory, wherein the surface processing plan comprises one of:
a force profile along the trajectory;
a velocity profile for the surface engaging tool along the trajectory;
a rotational speed profile, for the surface engaging tool, along the trajectory; or
a trajectory modification that accounts for the presence of a surface feature identified in the approximated surface topography; and
generate a control signal for the robotic arm that comprises the surface processing plan.

2. The system of claim 1, wherein the surface processing plan comprises a trajectory modification that accounts for the presence of a surface feature identified in the approximated surface topography, wherein the surface feature comprises a concave surface, a convex surface or an edge within the region.

3. The system of claim 1, wherein the surface processing plan comprises a trajectory modification that accounts for the presence of a surface feature identified in the approximated surface topography, wherein the trajectory modification comprises a discontinuous trajectory.

4. The system of claim 3, wherein the transformation moves the trajectory away from an identified surface feature.

5. The system of claim 1, wherein the trajectory comprises a series of waypoints through the region.

6. The system of claim 4, wherein the trajectory template is selected based on a defect size, defect location, defect type or defect severity, and wherein the surface processing plan comprises a trajectory modification that accounts for the presence of a surface feature identified in the approximated surface topography, wherein the trajectory modification is based on the identified surface feature.

7. (canceled)

8. The system of claim 1, wherein the robotic arm executes the control signal and follows the trajectory.

9. A repair plan generation system for a defect on a worksurface, the system comprising:
a surface sampling receiver that receives a surface topography of the worksurface;
a defect indication receiver that receives an indication of a defect on the worksurface;
a process constraint receiver that receives parameter constraints for a robotic repair unit;
a trajectory modifier that modifies a trajectory template, wherein the trajectory modifier comprises a transformer that transforms the trajectory template into a transformed trajectory, based on the surface topography;
a repair plan generator that generates a repair plan based on the transformed trajectory and comprises, along the transformed trajectory, sets process conditions, the repair plan generator comprising:
a force modulator that sets an applied force of a tool on the worksurface;
a velocity modulator that sets a velocity at which the tool moves across the worksurface;
a tool speed modulator that sets a rotational speed of the tool; and
a control signal generator that communicates the generated repair plan to a robot controller that automatically implements the repair plan and completes a defect repair based on the repair plan.

10. The system of claim 9, wherein the transformer:
projects the surface feature into a 2-dimensional plane;
maps the trajectory template to a boundary;
transforms the mapped trajectory template, wherein transforming comprises modifying a trajectory parameter; and
mapping the transformed trajectory to the surface topography, resulting in the transformed trajectory.

11. (canceled)

12. The system of claim 9, wherein the surface sampling receiver receives surface samples from a camera.

13. The system of claim 9, wherein the tool is a sander or polishing tool.

14. A method of removing material from a worksurface, the method comprising:
identifying a target area on the worksurface for material removal;
sampling a surface around the target area on the worksurface;
modeling the surface and, based on the model, detecting a surface topography;
modifying a surface processing trajectory, using a transformer, based on the detected surface topography, wherein the transformed surface processing trajectory comprises a continuous curve through a series of waypoints;
generating a repair plan comprising, at each of the waypoints:
an applied force;
a velocity;
a rotational tool speed of a tool; and
a tool angle with respect to the worksurface; and
transmitting a control signal to a robotic material removal system, wherein the control signal comprises the repair plan.

15. The method of claim 14, wherein the transformer transforms the surface processing trajectory by:
projecting the surface processing trajectory into a 2-dimensional plane;
mapping the surface process trajectory to a surface boundary within the surface topography;
transforming the mapped surface process trajectory; and
mapping the interpolated trajectory to a surface topography of the worksurface to obtain the transformed surface processing trajectory.

16. The method of claim 15, and further comprising:
smoothing the mapped surface process trajectory.

17. The method of claim 14, wherein modeling the surface comprises:
approximating the surface at each of a plurality of sampled surface locations;
approximating the curvature at each of the sampled surface locations; and
detecting a surface feature based on a derivative of the approximated curvature.

18. The method of claim 14, wherein the target area comprises a defect.

19. The method of claim 14, wherein sampling a surface comprises a vision system imaging the surface.

20. The method of claim 14, wherein the applied force at each of the waypoints is a modified applied force, modified by a force modifier based on the surface topography.

21. The method of claim 14, wherein modifying the surface processing trajectory comprises a homeomorphic transformation of a trajectory template.

22. The method of claim 14, wherein the modified trajectory comprises a discontinuous trajectory.

23-39. (canceled)
